(19) United States
(12) Patent Application Publication
(10) Pub. No.: US 2014/0295251 A1
(43) Pub. Date: Oct. 2, 2014

(54) ELECTRODE TERMINAL CONNECTION BODY, MANUFACTURING METHOD OF THE SAME AND ELECTRIC STORAGE SYSTEM

(71) Applicant: Hitachi Metals, Ltd., Tokyo (JP)

(72) Inventors: Toshiyuki HORIKOSHI, Mito (JP); Kotaro TANAKA, Naka-gun (JP); Takumi SATO, Hitachi (JP); Kenichi MURAKAMI, Hitachi (JP)

(73) Assignee: Hitachi Metals, Ltd., Tokyo (JP)

(21) Appl. No.: 14/209,822

(22) Filed: Mar. 13, 2014

(30) Foreign Application Priority Data
Mar. 26, 2013 (JP) 2013-064044

(51) Int. Cl. H01M 2/20; H01M 2/30

(52) U.S. Cl. CPC H01M 2/202; H01M 2/30
USPC 429/158; 29/882; 439/884

(57) ABSTRACT

A manufacturing method for an electrode terminal connection body includes applying a press processing to a plate member formed of the same kind of metal as a metal of a positive electrode terminal so as to form a mounting hole, slicing a covered metal rod more thickly than the plate member so as to form a covered metal member, the covered metal rod being configured to include an interposing layer formed of a metal that has an ionization tendency between the metal of the positive electrode terminal and the metal of a negative electrode terminal in the outer periphery of a metal rod formed of the same kind of metal as a metal of the negative electrode terminal and to have a diameter smaller than the mounting hole, and inserting the covered metal member into the inside of the mounting hole and simultaneously crushing the covered metal member.

The present application is based on Japanese patent applications No. 2013-064044 filed on Mar. 26, 2013, the entire contents of which are incorporated herein by reference.

### BACKGROUND OF TILL INVENTION

1. Field of the Invention

This invention relates to an electrode terminal connection body configured to electrically connect a positive electrode terminal and a negative electrode terminal that are formed of mutually different kinds of metal, and a manufacturing method of the electrode terminal connection body and an electric storage system using the electrode terminal connection body.

2. Description of the Related Art

In recent years, it is advancing to put a nonaqueous electrolyte secondary battery typified by a lithium ion secondary battery into practical use. The nonaqueous electrolyte secondary battery has a high energy output per unit area (or per unit mass) in comparison with the other batteries such as a lead storage battery, thus it is expected to be applicable to a mobile communication device and a book-size personal computer, an electric car and a hybrid car, and further an electrical power storage system using renewable energy such as a solar battery.

The nonaqueous electrolyte secondary battery mentioned above includes an electrode group configured such that a separator is arranged between a positive electrode and a negative electrode so as to form a multilayer structure, an exterior body configured to accommodate the electrode group, and an electrolytic solution enclosed in the exterior body.

As a base material of the positive electrode, aluminum is used, and as a base material of the negative electrode, copper is used. To the positive electrode, a positive electrode terminal comprised of aluminum or an aluminum alloy is electrically connected, and to the negative electrode, a negative electrode terminal comprised of copper or a copper alloy is electrically connected.

In a small sized device that has a small output, the nonaqueous electrolyte secondary battery is used as single body, but in a large sized device that needs a large output, naturally, the output of the single body of the nonaqueous electrolyte secondary battery is not enough, thus a configuration that a plurality of the nonaqueous electrolyte secondary batteries are connected in series-parallel is adopted so as to obtain a desired output.

In this case, it is necessary that the positive electrode terminal and the negative electrode terminal are electrically connected to each other, but as mentioned above, the positive electrode terminal and the negative electrode terminal are mutually formed of different kinds of metal, thus it is required to join mutually different kinds of metals. In case of joining mutually different kinds of metals, it is concerned that corrosion and increase in resistance are caused in the joining part by a local battery effect due to difference in an ionization tendency of the metals.

Also, with regard to joining itself, there is a problem that it is difficult to obtain stable joining strength by using a popular technique such as a resistance welding as a technique for joining metals with each other due to difference in melting point that the respective metals have. If stable joining strength is not obtained, it is not preferable in terms of vibration resistance.

For example, JP-A-2011-210482 discloses an electrode terminal connection body configured such that a positive electrode connection part configured to be connectable to a positive electrode and a negative electrode connection part configured to connectable to a negative electrode are included, and the negative electrode connection part is arranged so as to surround the periphery of the positive electrode connection part or the positive electrode connection part is arranged so as to surround the periphery of the negative electrode connection part, and simultaneously the positive electrode connection part and the negative electrode connection part are integrally bonded by metallic bond.

In addition, JP-A-2012-89254 discloses an electrode terminal connection body configured such that an electrode part configured to be connected to one electrode terminal and be formed of the same kind of metal as a metal of the one electrode terminal, and a bus bar part configured to be connected to the electrode part and be formed of the same kind of metal as a metal of another electrode terminal are included, and the electrode part and the bus bar part are integrated by diffusion junction.

According to these electrode terminal connection bodies, the joining of the electrode terminal connection body and the electrode terminal can be configured to be a joining of the mutually same kind of metal so that an occurrence of corrosion and increase in resistance due to a local battery effect can be prevented in principle, and a simple technique such as a resistance welding as a technique for a joining of metals can be adopted.

### SUMMARY OF THE INVENTION

The electrode terminal connection bodies disclosed in JP-A-2011-210482 and JP-A-2012-89254 are configured by joining mutually different kinds of metals originally, thus there is a possibility that also in the joining part thereof, corrosion and increase in resistance due to a local battery effect are caused.

It is an object of the invention to provide an electrode terminal connection body that is capable of preventing an occurrence of corrosion and increase in resistance in the joining part thereof, and a manufacturing method of the electrode terminal connection body and an electric storage system using the electrode terminal connection body.

(1) According to one embodiment of the invention, a manufacturing method for an electrode terminal connection body configured to electrically connect a positive electrode terminal and a negative electrode terminal that are formed of mutually different kinds of metals comprises:

applying a press processing to a plate member formed of the same kind of metal as a metal of the positive electrode terminal so as to form a mounting hole;

slicing a covered metal rod more thickly than the plate member so as to form a covered metal member, the covered metal rod being configured to include an interposing layer formed of a metal that has an ionization tendency between the metal of the positive electrode terminal and the metal of the negative electrode terminal in the outer periphery of a metal rod formed of the same kind of metal as a metal of the negative electrode terminal and to have a diameter smaller than the mounting hole; and

inserting the covered metal member into the inside of the mounting hole and simultaneously crushing the covered metal member in the inside of the mounting hole so as to join the plate member and the covered metal member by using the interposing layer as a boundary while expanding the mounting hole.

In the above embodiment (1) of the invention, the following modifications and changes can be made.

(i) The manufacturing method further comprises:

applying a press processing to the plate member so as to form a positive electrode terminal fixing hole; and

applying a press processing to the center part of the covered metal member to allow the covered metal member to remain in the inner peripheral part of the mounting hole so as to form a negative electrode terminal fixing hole.

(2) According to another embodiment of the invention, a manufacturing method for an electrode terminal connection body configured to electrically connect a positive electrode terminal and a negative electrode terminal that are formed of mutually different kinds of metals comprises:

applying a press processing to a plate member formed of the same kind of metal as a metal of the negative electrode terminal so as to form a mounting hole;

slicing a covered metal rod more thickly than the plate member so as to form a covered metal member, the covered metal rod being configured to include an interposing layer formed of a metal that has an ionization tendency between the metal of the positive electrode terminal and the metal of the negative electrode terminal in the outer periphery of a metal rod formed of the same kind of metal as a metal of the positive electrode terminal and to have a diameter smaller than the mounting hole; and

inserting the covered metal member into the inside of the mounting hole and simultaneously crushing the covered metal member in the inside of the mounting hole so as to join the plate member and the covered metal member by using the interposing layer as a boundary while expanding the mounting hole.

In the above embodiment (2) of the invention, the following modifications and changes can be made.

(ii) The manufacturing method further comprises:

applying a press processing to the plate member so as to form a negative electrode terminal fixing hole; and

applying a press processing to the center part of the covered metal member to allow the covered metal member to remain in the inner peripheral part of the mounting hole so as to form a positive electrode terminal fixing hole.

In the above embodiment (1) or (2) of the invention, the following modifications and changes can be made.

(iii) The manufacturing method further comprises:

heating under an inert atmosphere after joining the plate member and the covered metal member.

(3) According to another embodiment of the invention, a manufacturing method for an electrode terminal connection body configured to electrically connect a positive electrode terminal and a negative electrode terminal that are formed of mutually different kinds of metals comprises:

applying a press processing to a metal plate so as to form a positive electrode terminal side mounting hole and a negative electrode terminal side mounting hole;

slicing a positive electrode terminal side covered metal rod more thickly than the metal plate so as to form a positive electrode terminal side covered metal member, the positive electrode terminal side covered metal rod being configured to include a positive electrode terminal side interposing layer formed of a metal that has an ionization tendency between the metal of the positive electrode terminal and the metal of the metal plate in the outer periphery of a positive electrode terminal side metal rod formed of the same kind of metal as a metal of the positive electrode terminal and to have a diameter smaller than the positive electrode terminal side mounting hole;

slicing a negative electrode terminal side covered metal rod more thickly than the metal plate so as to form a negative electrode terminal side covered metal member, the negative electrode terminal side covered metal rod being configured to include a negative electrode terminal side interposing layer formed of a metal that has an ionization tendency between the metal of the negative electrode terminal and the metal of the metal plate in the outer periphery of a negative electrode terminal side metal rod formed of the same kind of metal as a metal of the negative electrode terminal and to have a diameter smaller than the negative electrode terminal side mounting hole; and

inserting the positive electrode terminal side covered metal member into the inside of the positive electrode terminal side mounting hole and simultaneously crushing the positive electrode terminal side covered metal member in the inside of the positive electrode terminal side mounting hole so as to join the metal plate and the positive electrode terminal side covered metal member by using the positive electrode terminal side interposing layer as a boundary while expanding the positive electrode terminal side mounting hole, and inserting the negative electrode terminal side covered metal member into the inside of the negative electrode terminal side mounting hole and simultaneously crushing the negative electrode terminal side covered metal member in the inside of the negative electrode terminal side mounting hole so as to join the metal plate and the negative electrode terminal side covered metal member by using the negative electrode terminal side interposing layer as a boundary while expanding the negative electrode terminal side mounting hole.

In the above embodiment (3) of the invention, the following modifications and changes can be made.

(iv) The metal plate comprises an aluminum based material or a copper based material.

(v) The manufacturing method further comprises:

applying a press processing to the center part of the positive electrode terminal side covered metal member to allow the positive electrode terminal side covered metal member to remain in the inner peripheral part of the positive electrode terminal side mounting hole so as to form a positive electrode terminal fixing hole; and

applying a press processing to the center part of the negative electrode terminal side covered metal member to allow the negative electrode terminal side covered metal member to remain in the inner peripheral part of the negative electrode terminal side mounting hole so as to form a negative electrode terminal fixing hole.

(vi) The manufacturing method further comprises:

heating under an inert atmosphere after joining the metal plate and the positive electrode terminal side covered metal member and joining the metal plate and the negative electrode terminal side covered metal member.

(4) According to another embodiment of the invention, a manufacturing method for an electrode terminal connection body configured to electrically connect a positive electrode terminal and a negative electrode terminal that are formed of mutually different kinds of metals comprises:

applying a press processing to a plate member formed of the same kind of metal as a metal of the positive electrode terminal so as to form a mounting hole;

slicing a covered metal rod in the same thickness as the plate member so as to form a covered metal member, the covered metal rod being configured to include an interposing layer formed of a metal that has an ionization tendency between the metal of the positive electrode terminal and the metal of the negative electrode terminal in the outer periphery of a metal rod formed of the same kind of metal as a metal of the negative electrode terminal and to have a diameter larger than the mounting hole; and

press-fitting the covered metal member into the inside of the mounting hole so as to join the plate member and the covered metal member by using the interposing layer as a boundary.

In the above embodiment (4) of the invention, the following modifications and changes can be made.

(vii) The manufacturing method further comprises:

applying a press processing to the plate member so as to form a positive electrode terminal fixing hole; and

applying a press processing to the center part of the covered metal member to allow the covered metal member to remain in the inner peripheral part of the mounting hole so as to form a negative electrode terminal fixing hole.

(5) According to another embodiment of the invention, a manufacturing method for an electrode terminal connection body configured to electrically connect a positive electrode terminal and a negative electrode terminal that are formed of mutually different kinds of metals comprises:

applying a press processing to a plate member formed of the same kind of metal as a metal of the negative electrode terminal so as to form a mounting hole;

slicing a covered metal rod in the same thickness as the plate member so as to form a covered metal member, the covered metal rod being configured to include an interposing layer formed of a metal that has an ionization tendency between the metal of the positive electrode terminal and the metal of the negative electrode terminal in the outer periphery of a metal rod formed of the same kind of metal as a metal of the positive electrode terminal and to have a diameter larger than the mounting hole; and

press-fitting the covered metal member into the inside of the mounting hole so as to join the plate member and the covered metal member by using the interposing layer as a boundary.

In the above embodiment (4) or (5) of the invention, the following modifications and changes can be made.

(viii) The manufacturing method further comprises:

applying a press processing to the plate member so as to form a negative electrode terminal fixing hole; and

applying a press processing to the center part of the covered metal member to allow the covered metal member to remain in the inner peripheral part of the mounting hole so as to form a positive electrode terminal fixing hole.

(ix) The manufacturing method further comprises:

heating under an inert atmosphere after joining the plate member and the covered metal member.

(x) The outer diameter of the metal rod is smaller than the mounting hole.

(6) According to another embodiment of the invention, a manufacturing method for an electrode terminal connection body configured to electrically connect a positive electrode terminal and a negative electrode terminal that are formed of mutually different kinds of metals comprises:

applying a press processing to a metal plate so as to form a positive electrode terminal side mounting hole and a negative electrode terminal side mounting hole;

slicing a positive electrode terminal side covered metal rod in the same thickness as the metal plate so as to form a positive electrode terminal side covered metal member, the positive electrode terminal side covered metal rod being configured to include a positive electrode terminal side interposing layer formed of a metal that has an ionization tendency between the metal of the positive electrode terminal and the metal of the metal plate in the outer periphery of a positive electrode terminal side metal rod formed of the same kind of metal as a metal of the positive electrode terminal and to have a diameter larger than the positive electrode terminal side mounting hole;

slicing a negative electrode terminal side covered metal rod in the same thickness as the metal plate so as to form a negative electrode terminal side covered metal member, the negative electrode terminal side covered metal rod being configured to include a negative electrode terminal side interposing layer formed of a metal that has an ionization tendency between the metal of the negative electrode terminal and the metal of the metal plate in the outer periphery of a negative electrode terminal side metal rod formed of the same kind of metal as a metal of the negative electrode terminal and to have a diameter larger than the negative electrode terminal side mounting hole; and

press-fitting the positive electrode terminal side covered metal member into the inside of the positive electrode terminal side mounting hole so as to join the plate member and the positive electrode terminal side covered metal member by using the positive electrode terminal side interposing layer as a boundary and press-fitting the negative electrode terminal side covered metal member into the inside of the negative electrode terminal side mounting hole so as to join the plate member and the negative electrode terminal side covered metal member by using the negative electrode terminal side interposing layer as a boundary.

In the above embodiment (6) of the invention, the following modifications and changes can be made.

(xi) The metal plate comprises an aluminum based material or a copper based material.

(xii) The manufacturing method further comprises:

applying a press processing to the center part of the positive electrode terminal side covered metal member to allow the positive electrode terminal side covered metal member to remain in the inner peripheral part of the positive electrode terminal side mounting hole so as to form a positive electrode terminal fixing hole; and

applying a press processing to the center part of the negative electrode terminal side covered metal member to allow the negative electrode terminal side covered metal member to remain in the inner peripheral part of the negative electrode terminal side mounting hole so as to form a negative electrode terminal fixing hole.

(xiii) The manufacturing method further comprises:

heating under an inert atmosphere after joining the metal plate and the positive electrode terminal side covered metal member and joining the metal plate and the negative electrode terminal side covered metal member.

(xiv) The outer diameter of the positive electrode terminal side metal rod is smaller than the positive electrode terminal side mounting hole, and wherein the outer diameter of the negative electrode terminal side metal rod is smaller than the negative electrode terminal side mounting hole.

(7) According to another embodiment of the invention, an electrode terminal connection body configured to electrically connect a positive electrode terminal and a negative electrode terminal that are formed of mutually different kinds of metals comprises:

a positive electrode terminal connection part formed of the same kind of metal as a metal of the positive electrode terminal; and

a negative electrode terminal connection part formed of the same kind of metal as a metal of the negative electrode terminal,

wherein the positive electrode terminal connection part and the negative electrode terminal connection part are connected via an interposing part formed of a metal that has an ionization tendency between the metal of the positive electrode terminal and the metal of the negative electrode terminal.

(8) According to another embodiment of the invention, an electrode terminal connection body configured to electrically connect a positive electrode terminal and a negative electrode terminal that are formed of mutually different kinds of metals, comprising:

a metal plate;

a positive electrode terminal connection part disposed in a part of the metal plate and formed of the same kind of metal as a metal of the positive electrode terminal; and

a negative electrode terminal connection part disposed in a part of the metal plate and formed of the same kind of metal as a metal of the negative electrode terminal,

wherein the positive electrode terminal connection part and the metal plate are connected via a positive electrode terminal side interposing part formed of a metal that has an ionization tendency between the metal of the positive electrode terminal and the metal of the metal plate, and the negative electrode terminal connection part and the metal plate are connected via a negative electrode terminal side interposing part formed of a metal that has an ionization tendency between the metal of the negative electrode terminal and the metal of the metal plate.

(9) According to another embodiment of the invention, an electric storage system comprises:

a plurality of the nonaqueous electrolyte secondary batteries comprising a positive electrode terminal and a negative electrode terminal; and

an electrode terminal connection body configured to electrically connect the positive electrode terminal and the negative electrode terminal that are formed of mutually different kinds of metals, comprising a positive electrode terminal connection part formed of the same kind of metal as a metal of the positive electrode terminal; and a negative electrode terminal connection part formed of the same kind of metal as a metal of the negative electrode terminal, wherein the positive electrode terminal connection part and the negative electrode terminal connection part are connected via an interposing part formed of a metal that has an ionization tendency between the metal of the positive electrode terminal and the metal of the negative electrode terminal,

wherein the positive electrode terminal connection part of the electrode terminal connection body is connected to the positive electrode terminal of one nonaqueous electrolyte secondary battery and the negative electrode terminal connection part of the electrode terminal connection body is connected to the negative electrode terminal of the other nonaqueous electrolyte secondary battery so that the positive electrode terminal and the negative electrode terminal of the nonaqueous electrolyte secondary batteries are electrically connected in series-parallel via the electrode terminal connection body.

(10) According to another embodiment of the invention, an electric storage system comprises:

a plurality of the nonaqueous electrolyte secondary batteries comprising a positive electrode terminal and a negative electrode terminal; and

an electrode terminal connection body configured to electrically connect the positive electrode terminal and the negative electrode terminal that are formed of mutually different kinds of metals, comprising a metal plate a positive electrode terminal connection part disposed in a part of the metal plate and formed of the same kind of metal as a metal of the positive electrode terminal and a negative electrode terminal connection part disposed in a part of the metal plate and formed of the same kind of metal as a metal of the negative electrode terminal, wherein the positive electrode terminal connection part and the metal plate are connected via a positive electrode terminal side interposing part formed of a metal that has an ionization tendency between the metal of the positive electrode terminal and the metal of the metal plate, and the negative electrode terminal connection part and the metal plate are connected via a negative electrode terminal side interposing part formed of a metal that has an ionization tendency between the metal of the negative electrode terminal and the metal of the metal plate,

wherein the positive electrode terminal connection part of the electrode terminal connection body is connected to the positive electrode terminal of one nonaqueous electrolyte secondary battery and the negative electrode terminal connection part of the electrode terminal connection body is connected to the negative electrode terminal of the other nonaqueous electrolyte secondary battery so that the positive electrode terminal and the negative electrode terminal of the nonaqueous electrolyte secondary batteries are electrically connected in series-parallel via the electrode terminal connection body.

### Effects of the Invention

According to one embodiment of the invention, an electrode terminal connection body can be provided that is capable of preventing an occurrence of corrosion and increase in resistance in the joining part thereof, as well as a manufacturing method of the electrode terminal connection body and an electric storage system using the electrode terminal connection body.

### BRIEF DESCRIPTION OF THE DRAWINGS

The preferred embodiment according to the invention will be explained below referring to the drawings, wherein:

FIG. 1A is a top view schematically showing an electrode terminal connection body according to one embodiment of the invention;

FIG. 1B is a cross-sectional view taken along the line A-A in FIG. 1A;

FIG. 2 is a perspective view schematically showing an electric storage system according to the one embodiment of the invention configured such that a plurality of nonaqueous electrolyte secondary batteries are connected in series via the electrode terminal connection body shown in FIGS. 1A, 1B;

FIG. 3A is a top view schematically showing an electrode terminal connection body according to another embodiment of the invention;

FIG. 3B is a cross-sectional view taken along the line B-B in FIG. 3A;

FIG. 4 is a perspective view schematically showing an electric storage system according to the another embodiment of the invention configured such that a plurality of nonaqueous electrolyte secondary batteries are connected in series via the electrode terminal connection body shown in FIGS. 3A, 3B;

FIGS. 5A to 5F are explanatory cross-sectional views schematically showing a manufacturing method of an expansion type according to the one embodiment of the invention for obtaining the electrode terminal connection body shown in FIGS. 1A, 1B;

FIGS. 6A to 6G are explanatory cross-sectional views schematically showing a manufacturing method of an expansion type according to the another embodiment of the invention for obtaining the electrode terminal connection body shown in FIGS. 3A, 3B;

FIGS. 7A to 7F are explanatory cross-sectional views schematically showing a manufacturing method of a press-fitting type according to the one embodiment of the invention for obtaining the electrode terminal connection body shown in FIGS. 1A, 1B; and

FIGS. 8A to 8G are explanatory cross-sectional views schematically showing a manufacturing method of a press-fitting type according to the another embodiment of the invention for obtaining the electrode terminal connection body shown in FIGS. 3A, 3B.

### DETAILED DESCRIPTION OF THE PREFERRED EMBODIMENTS

Hereinafter, the preferred embodiment according to the invention will be explained below referring to the drawings.

First, a first and second electrode terminal connection body according to the embodiment of the invention will be explained.

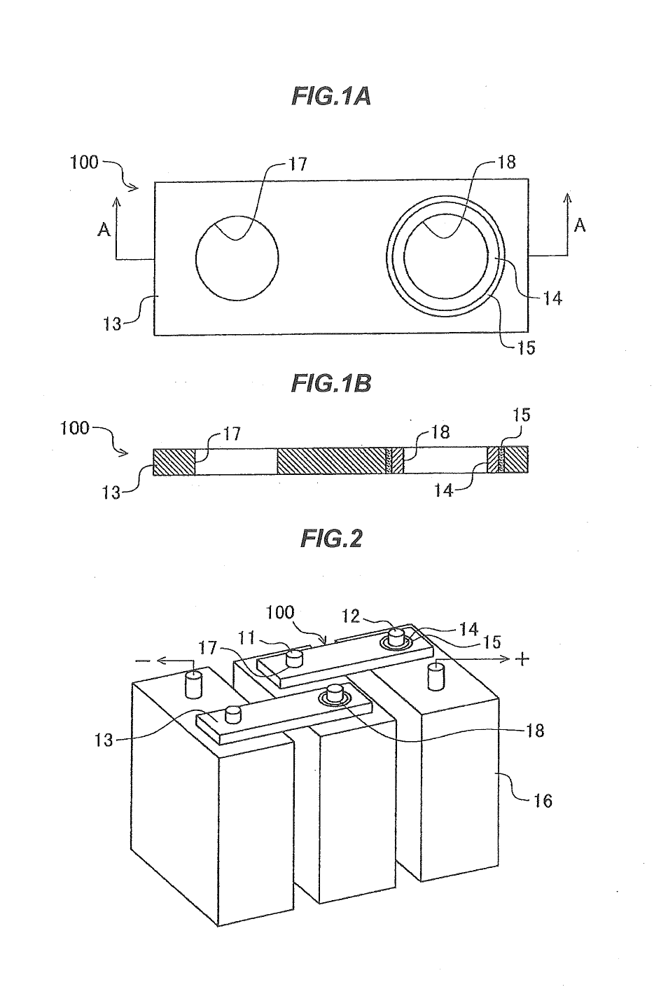

As shown in FIGS. 1A, 1B and FIG. 2, the first electrode terminal connection body 100 is configured to electrically connect a positive electrode terminal 11 and a negative electrode terminal 12 that are formed of mutually different kinds of metals, and includes a positive electrode terminal connection part 13 formed of the same kind of metal as a metal of the positive electrode terminal 11 and a negative electrode terminal connection part 14 formed of the same kind of metal as a metal of the negative electrode terminal 12, wherein the positive electrode terminal connection part 13 and the negative electrode terminal connection part 14 are connected via an interposing part 15 formed of a metal that has an ionization tendency between the metal of the positive electrode terminal 11 and the metal of the negative electrode terminal 12.

The positive electrode terminal 11 and the negative electrode terminal 12 are respectively formed so as to extend from the nonaqueous electrolyte secondary battery 16. The positive electrode terminal 11 is comprised of aluminum or an aluminum alloy, and the negative electrode terminal 12 is comprised of copper or a copper alloy.

A plurality of the nonaqueous electrolyte secondary batteries 16 are connected in series-parallel via the first electrode terminal connection body 100, for example, constitutes a battery system that is mounted in an electric car and a hybrid car as a motive power thereof.

The positive electrode terminal connection part 13 is a part that is configured to be electrically connected to the positive electrode terminal 11 and the negative electrode terminal connection part 14 is a part that is configured to be electrically connected to the negative electrode terminal 12.

Here, a configuration that the same kind of metal as a metal of the positive electrode terminal 11 is used as a main base material is explained, but not limited to this, a configuration that the same kind of metal as a metal of the negative electrode terminal 12 is used as a main base material and the positive electrode terminal connection part 13 is formed in a part of the negative electrode terminal connection part 14 can be also adopted.

In the positive electrode terminal connection part 13, a positive electrode terminal fixing hole 17 is formed, the positive electrode terminal fixing hole 17 being configured such that the positive electrode terminal 11 is inserted therein so as to be fixed by resistance welding or the like, and in the negative electrode terminal connection part 14, a negative electrode terminal fixing hole 18 is formed, the negative electrode terminal fixing hole 18 being configured such that the negative electrode terminal 12 is inserted therein so as to be fixed by resistance welding or the like.

The interposing part 15 is configured to prevent an occurrence of corrosion and increase in resistance in the joining part of the positive electrode terminal connection part 13 and the negative electrode terminal connection part 14, and for example, is comprised of nickel, chromium, zinc or the like.

Here, a metal of the interposing part 15 is selected based on an ionization tendency, but a configuration using a base other than the ionization tendency can be adopted, that a metal having a standard electrode potential located between the metal of the positive electrode terminal 11 and the metal of the negative electrode terminal 12 is selected as the metal of the interposing part 15. The reason is that an ionization permutation exhibiting the ionization tendency corresponds to electrochemical series exhibiting the standard electrode potential that is represented by using hydrogen as a standard electrode.

In accordance with the first electrode terminal connection body 100 according to the embodiment, the positive electrode terminal connection part 13 and the negative electrode terminal connection part 14 are connected via the interposing part 15 formed of a metal that has an ionization tendency between the metal of the positive electrode terminal 11 and the metal of the negative electrode terminal 12, thus the change of not only the ionization tendency in the connection interface between the positive electrode terminal connection part 13 and the negative electrode terminal connection part 14, but also the electric potential difference of the standard electrode potential in the connection interface can be reduced, and an occurrence of corrosion and increase in resistance in the joining part of the electrode terminal connection body 10 due to a local battery effect can be prevented.

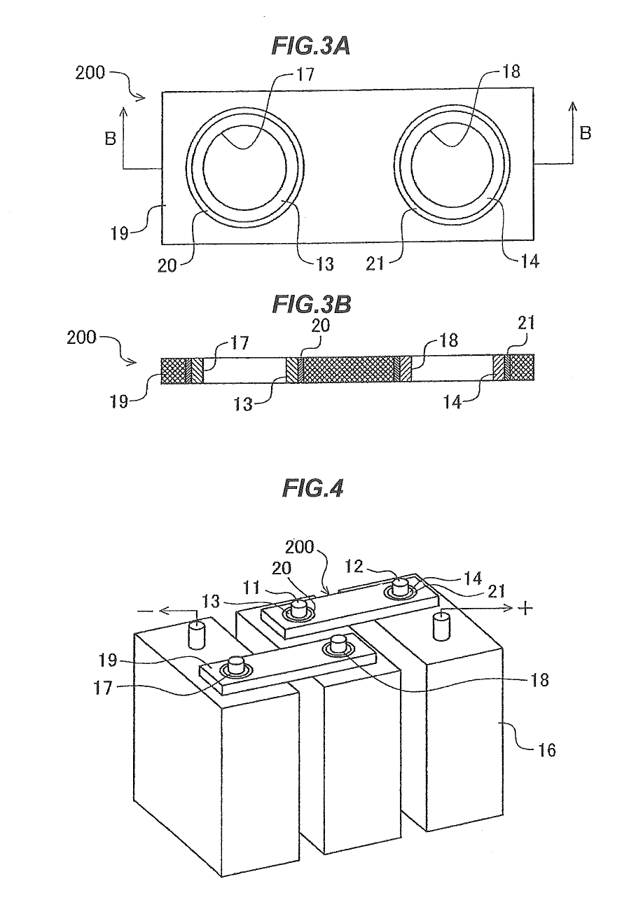

As shown in FIGS. 3A, 3B and FIG. 4, the second electrode terminal connection body 200 is configured to electrically connect a positive electrode terminal 11 and a negative electrode terminal 12 that are formed of mutually different kinds of metals, and includes a metal plate 19, a positive electrode terminal connection part 13 disposed in a part of the metal plate 19 and formed of the same kind of metal as a metal of the positive electrode terminal 11 and a negative electrode terminal connection part 14 disposed in a part of the metal plate 19 and formed of the same kind of metal as a metal of the negative electrode terminal 12, wherein the positive electrode terminal connection part 13 and the metal plate 19 are connected via a positive electrode terminal side interposing part 20 formed of a metal that has an ionization tendency between the metal of the positive electrode terminal 11 and the metal of the metal plate 19, and the negative electrode terminal connection part 14 and the metal plate 19 are connected via a negative electrode terminal side interposing part 21 formed of a metal that has an ionization tendency between the metal of the negative electrode terminal 12 and the metal of the metal plate 19.

It is preferable that the metal plate 19 is comprised of an aluminum based material or a copper based material. This is because the aluminum based material is selected as a material of the metal plate 19, thereby a weight reduction of the second electrode terminal connection body 200 can be realized, in addition, the copper based material is selected as a material of the metal plate 19, thereby a resistance reduction of the second electrode terminal connection body 200 can be realized (conductivity thereof can be heightened).

A specific embodiment of the aluminum based material includes pure aluminum, and a specific embodiment of the copper based material includes tough pitch copper, oxygen free copper and the like.

Further, a configuration that a material of the metal plate 19 is formed of the same kind of material as a material of the positive electrode terminal connection part 13 or the negative electrode terminal connection part 14 shall not be excluded.

The positive electrode terminal side interposing part 20 is configured to prevent an occurrence of corrosion and increase in resistance in the joining part of the positive electrode terminal connection part 13 and the metal plate 19, and the negative electrode terminal side interposing part 21 is configured to prevent an occurrence of corrosion and increase in resistance in the joining part of the negative electrode terminal connection part 14 and the metal plate 19.

Here, metals of the positive electrode terminal side interposing part 20 and the negative electrode terminal side interposing part 21 are selected based on an ionization tendency, but a configuration using a base other than the ionization tendency can be adopted, that a metal having a standard electrode potential located between the metal of the positive electrode terminal 11 and the metal of the metal plate 19 is selected as the metal of the positive electrode terminal side interposing part 20, and a metal having a standard electrode potential located between the metal of the negative electrode terminal 12 and the metal of the metal plate 19 is selected as the metal of the negative electrode terminal side interposing part 21. Because an ionization permutation exhibiting the ionization tendency corresponds to electrochemical series exhibiting the standard electrode potential that is represented by using hydrogen as a standard electrode.

In accordance with the second electrode terminal connection body 200 according to the embodiment, the main base material that occupies most of the whole volume is formed of the metal plate 19, thus a material of the metal plate 19 is changed in accordance with purposes, thereby materials having various characteristics can be freely used as the main base material.

In addition, the second electrode terminal connection body 200 is configured such that the positive electrode terminal connection part 13 and the negative electrode terminal connection part 14 that are formed of a material different from that of the metal plate 19 are disposed in only a part of the metal plate 19, thus material characteristics of the positive electrode terminal connection part 13 and the negative electrode terminal connection part 14 exert an extremely small influence on the whole characteristics of the second electrode terminal connection body 200 so that characteristics of the second electrode terminal connection body 200 can be freely designed by selecting a material of the metal plate 19.

Furthermore, the positive electrode terminal connection part 13 and the metal plate 19 are connected via the positive electrode terminal side interposing part 20 formed of a metal that has an ionization tendency between the metal of the positive electrode terminal 11 and the metal of the metal plate 19, and the negative electrode terminal connection part 14 and the metal plate 19 are connected via the negative electrode terminal side interposing part 21 formed of a metal that has an ionization tendency between the metal of the negative electrode terminal 12 and the metal of the metal plate 19, thus the change of not only the ionization tendency in the connection interface between the positive electrode terminal connection part 13 and the metal plate 19, and the connection interface between the negative electrode terminal connection part 14 and the metal plate 19, but also the electric potential difference of the standard electrode potential in the connection interface can be reduced, and an occurrence of corrosion and increase in resistance in the joining part of the second electrode terminal connection body 200 due to a local battery effect can be prevented.

Next, a manufacturing method of the electrode terminal connection body will be explained. In the manufacturing method of the electrode terminal connection body, an expansion type manufacturing method and a press-fitting type manufacturing method are mainly included, thus these manufacturing methods will be explained in order.

First, the expansion type manufacturing method will be explained.

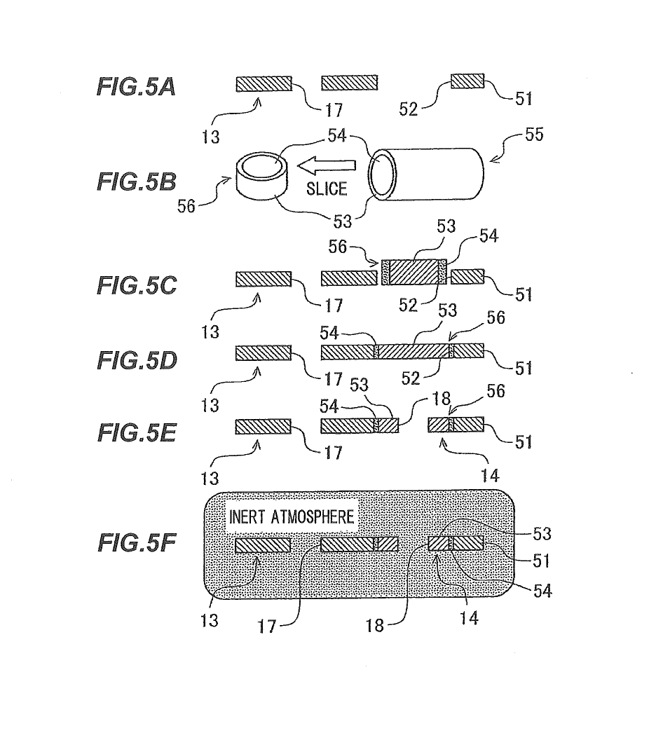

As shown FIG. 5A to 5F, a manufacturing method of an expansion type for obtaining the first electrode terminal connection body 100, includes applying a press processing to a plate member 51 formed of the same kind of metal as a metal of the positive electrode terminal 11 so as to form a mounting hole 52, slicing a covered metal rod 55 more thickly than the plate member 51 so as to form a covered metal member 56, the covered metal rod 55 being configured to include an interposing layer 54 formed of a metal that has an ionization tendency between the metal of the positive electrode terminal 11 and the metal of the negative electrode terminal 12 in the outer periphery of a metal rod 53 formed of the same kind of metal as a metal of the negative electrode terminal 12 and to have a diameter smaller than the mounting hole 52, and inserting the covered metal member 56 into the inside of the mounting hole 52 and simultaneously crushing the covered metal member 56 in the inside of the mounting hole 52 so as to join the plate member 51 and the covered metal member 56 by using the interposing layer 54 as a boundary while expanding the mounting hole 52.

Further, in FIGS. 5A to 5F, for convenience of explanation, a part of lines in the cross-sectional views is omitted.

Hereinafter, the respective steps will be concretely explained.

The step of applying a press processing to the plate member 51 formed of the same kind of metal as a metal of the positive electrode terminal 11 so as to form the mounting hole 52 is particularly carried out to apply a press processing (especially, a punching work) to the plate member 51 formed of aluminum or an aluminum alloy so as to form the mounting hole 52, and further to form the positive electrode terminal fixing hole 17 so as to form the positive electrode terminal connection part 13 (refer to FIG. 5A). Just after this step, an oxidizing film is not formed in the inner peripheral surface of the mounting hole 52.

Thereby, when the positive electrode terminal 11 is inserted into the positive electrode terminal fixing hole 17 so as to be fixed by resistance welding or the like, the positive electrode terminal 11 and the plate member 51 that are mutually formed of the same kind of metal are brought into contact with each other so that the joining of the mutually same kind of metal can be realized.

The step of slicing a covered metal rod 55 more thickly than the plate member 51 so as to form a covered metal member 56, the covered metal rod 55 being configured to include an interposing layer 54 formed of a metal that has an ionization tendency between the metal of the positive electrode terminal 11 and the metal of the negative electrode terminal 12 in the outer periphery of a metal rod 53 formed of the same kind of metal as a metal of the negative electrode terminal 12 and to have a diameter smaller than the mounting hole 52 is particularly carried out to cover the outer periphery of the metal rod 53 formed of copper or a copper alloy with the interposing layer 54 formed of nickel, chromium, zinc or the like that becomes the interposing part 15 by a plating processing, a vapor deposition processing or the like so as to form the covered metal rod 55, and slice the covered metal rod 55 by using a slicer or the like so as to form the covered metal member 56 (refer to FIG. 5B).

A plating processing, a vapor deposition processing or the like is adopted, thereby the interposing layer 54 can be adjusted to have a thickness that is necessary and minimum, thus even if the material constituting the interposing layer 54 is not desired for characteristics of the first electrode terminal connection body 100, an influence due to this can be suppressed to a minimum.

Here, a metal of the interposing layer 54 is selected based on an ionization tendency, but a configuration using a base other than the ionization tendency can be adopted, that a metal having a standard electrode potential located between the metal of the positive electrode terminal 11 and the metal of the negative electrode terminal 12 is selected as the metal of the interposing layer 54. The reason is that an ionization permutation exhibiting the ionization tendency corresponds to electrochemical series exhibiting the standard electrode potential that is represented by using hydrogen as a standard electrode.

The step of inserting the covered metal member 56 into the inside of the mounting hole 52 and simultaneously crushing the covered metal member 56 in the inside of the mounting hole 52 so as to join the plate member 51 and the covered metal member 56 by using the interposing layer 54 as a boundary while expanding the mounting hole 52 is particularly carried out to crush the covered metal member 56 in the inside of the mounting hole 52 by a blanking punch of a press device (refer to FIGS. 5C and 5D).

At this time, the covered metal member 56 is crushed, and is rolled so as to have a diameter larger than the inner diameter of the mounting hole 52, in association with this, the mounting hole 52 is expanded. As a result, even if an oxide film is slightly formed in the inner peripheral surface of the mounting hole 52, the oxide film is broken just before the joining, and generation of a newly formed surface is accelerated so that diffusion joining can be carried out between aluminum or the like of the plate member 51 and nickel or the like of the interposing layer 54.

Consequently, aluminum or the like of the plate member 51 and nickel or the like of the interposing layer 54 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, aluminum or the like of the plate member 51 and nickel or the like of the interposing layer 54, and nickel or the like of the interposing layer 54 and copper or the like of the metal rod 53 have the respective ionization tendencies being close together, thus even if these mutually different kinds of metals are joined, in principle, corrosion and increase in resistance by a local battery effect is hard to occur.

Further, it is preferable that the step of forming the covered metal member 56 is preliminarily carried out before the step of forming the mounting hole 52. The covered metal member 56 is prepared first, and then the mounting hole 52 is formed, thereby a time from the forming of the mounting hole 52 to the joining of the plate member 51 and the covered metal member 56 can be shortened, thus growth of the oxide film can be prevented.

In addition, a press processing has a processing speed higher than the other processing method, thus the above-mentioned steps can be continuously carried out by a press device, thereby the time can be further shortened. Consequently, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by expansion is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the covered metal member 56 joined to the plate member 51 by using the interposing layer 54 as a boundary so as to form the negative electrode terminal fixing hole 18 and fabricate the negative electrode terminal connection part 14 (refer to FIG. 5E).

At this time, a press processing is applied to the center part of the covered metal member 56 to allow the metal rod 53 to remain in the inner peripheral part of the mounting hole 52 so as to form the negative electrode terminal fixing hole 18.

Thereby, when the negative electrode terminal 12 is inserted into the negative electrode terminal fixing hole 18 so as to be fixed by resistance welding or the like, the negative electrode terminal 12 and a part of the metal rod 53 that are mutually formed of the same kind of metal are brought into contact with each other so that the joining of the mutually same kind of metal can be realized.

Further, when the negative electrode terminal fixing hole 18 is formed, in order to prevent the joining of mutually different kinds of metals it is preferable that the interposing layer 54 is not exposed in the inner peripheral surface of the negative electrode terminal fixing hole 18 that comes into contact with the negative electrode terminal 12.

In addition, it is preferable that the expansion type manufacturing method for obtaining the first electrode terminal connection body 100 further includes the step of heating under an inert atmosphere after joining the plate member 51 and the covered metal member 56 (refer to FIG. 5F).

Thereby, diffusion joining between aluminum or the like of the plate member 51 and nickel or the like of the interposing layer 54 and diffusion joining between nickel or the like of the interposing layer 54 and copper or the like of the metal rod 53 are sufficiently progressed so that joining strength can be further heightened.

As the inert atmosphere, a helium gas atmosphere or an argon gas atmosphere can be used. The heating temperature is controlled to a temperature not more than the melting point of the plate member 51, the metal rod 53 and the interposing layer 54 that are base materials.

When the nonaqueous electrolyte secondary batteries 16 are connected in series-parallel via the first electrode terminal connection body 100 obtained by the above-mentioned steps, the positive electrode terminal fixing hole 17 of the first electrode terminal connection body 100 and the positive electrode terminal 11 of the one nonaqueous electrolyte secondary battery 16 are fixed by resistance welding or the like, and the negative electrode terminal fixing hole 18 of the first electrode terminal connection body 100 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the plate member 51 that is the same kind of metal as a metal of the positive electrode terminal 11, and the negative electrode terminal fixing hole 18 that comes into contact with the negative electrode terminal 12 is formed of the a part of the metal rod 53 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Further, in the embodiment, the plate member 51 is formed of aluminum or the like that is the same kind of metal as a metal of the positive electrode terminal 11 and the metal rod 53 is formed of copper or the like that is the same kind of metal as a metal of the negative electrode terminal 12, but not limited to this, a configuration that the plate member 51 is formed of copper or the like that is the same kind of metal as a metal of the negative electrode terminal 12 and the metal rod 53 is formed of aluminum or the like that is the same kind of metal as a metal of the positive electrode terminal 11 may be also adopted.

Also in this case, when the mounting hole 52 and the covered metal member 56 are joined, even if an oxide film is slightly formed in the inner peripheral surface of the mounting hole 52, the oxide film is broken just before the joining, and generation of a newly formed surface is accelerated so that sufficient joining strength can be obtained between mutually different kinds of metals.

In addition, in the embodiment, the covered metal rod 55 is formed by covering the outer periphery of the metal rod 53 with the interposing layer 54 by a plating processing, a vapor deposition processing or the like, but limited to this, a configuration that a metal that becomes the metal rod 53 is press-fitted into the inside of a pipe member that becomes the interposing layer 54 and the obtained product is extended so as to form the covered metal rod 55 can be also adopted.

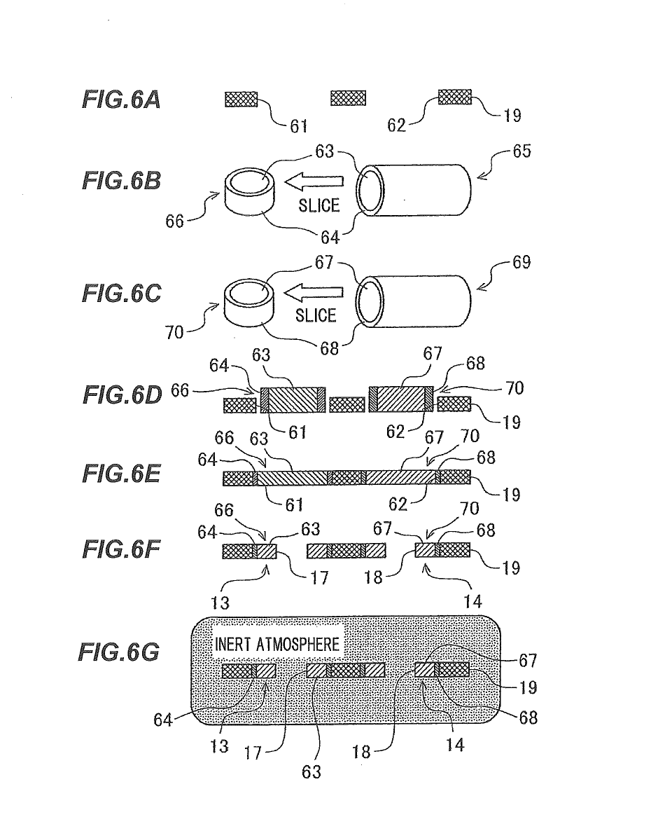

As shown in FIGS. 6A to 6Q a manufacturing method of an expansion type for obtaining the second electrode terminal connection body 200, includes applying a press processing to a metal plate 19 so as to form a positive electrode terminal side mounting hole 61 and a negative electrode terminal side mounting hole 62, slicing a positive electrode terminal side covered metal rod 65 more thickly than the metal plate 19 so as to form a positive electrode terminal side covered metal member 66, the positive electrode terminal side covered metal rod 65 being configured to include a positive electrode terminal side interposing layer 64 formed of a metal that has an ionization tendency between the metal of the positive electrode terminal 11 and the metal of the metal plate 19 in the outer periphery of a positive electrode terminal side metal rod 63 formed of the same kind of metal as a metal of the positive electrode terminal 11 and to have a diameter smaller than the positive electrode terminal side mounting hole 61, slicing a negative electrode terminal side covered metal rod 69 more thickly than the metal plate 19 so as to form a negative electrode terminal side covered metal member 70, the negative electrode terminal side covered metal rod 69 being configured to include a negative electrode terminal side interposing layer 68 formed of a metal that has an ionization tendency between the metal of the negative electrode terminal 12 and the metal of the metal plate 19 in the outer periphery of a negative electrode terminal side metal rod 67 formed of the same kind of metal as a metal of the negative electrode terminal 12 and to have a diameter smaller than the negative electrode terminal side mounting hole 62, and inserting the positive electrode terminal side covered metal member 66 into the inside of the positive electrode terminal side mounting hole 61 and simultaneously crushing the positive electrode terminal side covered metal member 66 in the inside of the positive electrode terminal side mounting hole 61 so as to join the metal plate 19 and the positive electrode terminal side covered metal member 66 by using the positive electrode terminal side interposing layer 64 as a boundary while expanding the positive electrode terminal side mounting hole 61, and inserting the negative electrode terminal side covered metal member 70 into the inside of the negative electrode terminal side mounting hole 62 and simultaneously crushing the negative electrode terminal side covered metal member 70 in the inside of the negative electrode terminal side mounting hole 62 so as to join the metal plate 19 and the negative electrode terminal side covered metal member 70 by using the negative electrode terminal side interposing layer 68 as a boundary while expanding the negative electrode terminal side mounting hole 62.

Further, in FIGS. 6A to 6G for convenience of explanation, a part of lines in the cross-sectional views is omitted.

Hereinafter, the respective steps will be concretely explained.

The step of applying a press processing to a metal plate 19 so as to form the positive electrode terminal side mounting hole 61 and the negative electrode terminal side mounting hole 62 is particularly carried out to apply a press processing (especially, a punching work) to the metal plate 19 formed of various materials in accordance with purposes such as an aluminum based material or a copper based material so as to form the positive electrode terminal side mounting hole 61 and the negative electrode terminal side mounting hole 62 (refer to FIG. 6A). Just after this step, an oxidizing film is not formed in the inner peripheral surfaces of the positive electrode terminal side mounting hole 61 and the negative electrode terminal side mounting hole 62.

The step of slicing a positive electrode terminal side covered metal rod 65 more thickly than the metal plate 19 so as to form a positive electrode terminal side covered metal member 66, the positive electrode terminal side covered metal rod 65 being configured to include a positive electrode terminal side interposing layer 64 formed of a metal that has an ionization tendency between the metal of the positive electrode terminal 11 and the metal of the metal plate 19 in the outer periphery of a positive electrode terminal side metal rod 63 formed of the same kind of metal as a metal of the positive electrode terminal 11 and to have a diameter smaller than the positive electrode terminal side mounting hole 61 is particularly carried out to cover the outer periphery of the positive electrode terminal side metal rod 63 formed of aluminum or an aluminum alloy with the positive electrode terminal side interposing layer 64 that becomes the positive electrode terminal side interposing part 20 by a plating processing, a vapor deposition processing or the like so as to form the positive electrode terminal side covered metal rod 65, and slice the positive electrode terminal side covered metal rod 65 by using a slicer or the like so as to form the positive electrode terminal side covered metal member 66 (refer to FIG. 6 B).

The step of slicing a negative electrode terminal side covered metal rod 69 more thickly than the metal plate 19 so as to form a negative electrode terminal side covered metal member 70, the negative electrode terminal side covered metal rod 69 being configured to include a negative electrode terminal side interposing layer 68 formed of a metal that has an ionization tendency between the metal of the negative electrode terminal 12 and the metal of the metal plate 19 in the outer periphery of a negative electrode terminal side metal rod 67 formed of the same kind of metal as a metal of the negative electrode terminal 12 and to have a diameter smaller than the negative electrode terminal side mounting hole 62 is particularly carried out to cover the outer periphery of the negative electrode terminal side metal rod 67 formed of copper or a copper alloy with the negative electrode terminal side interposing layer 68 that becomes the negative electrode terminal side interposing part 21 by a plating processing, a vapor deposition processing or the like so as to form the negative electrode terminal side covered metal rod 69, and slice the negative electrode terminal side covered metal rod 69 by using a slicer or the like so as to form the negative electrode terminal side covered metal member 70 (refer to FIG. 6C).

A plating processing, a vapor deposition processing or the like is adopted, thereby the positive electrode terminal side interposing layer 64 and the negative electrode terminal side interposing layer 68 can be adjusted to have a thickness that is necessary and minimum, thus even if the materials constituting the positive electrode terminal side interposing layer 64 and the negative electrode terminal side interposing layer 68 are not desired for characteristics of the second electrode terminal connection body 200, an influence due to this can be suppressed to a minimum.

Here, metals of the positive electrode terminal side interposing layer 64 and the negative electrode terminal side interposing layer 68 are selected based on an ionization tendency, but a configuration using a base other than the ionization tendency can be adopted, that a metal having a standard electrode potential located between the metal of the positive electrode terminal 11 and the metal of the metal plate 19 is selected as the metal of the positive electrode terminal side interposing layer 64, and a metal having a standard electrode potential located between the metal of the negative electrode terminal 12 and the metal of the metal plate 19 is selected as the metal of the negative electrode terminal side interposing layer 68. The reason is that an ionization permutation exhibiting the ionization tendency corresponds to electrochemical series exhibiting the standard electrode potential that is represented by using hydrogen as a standard electrode.

The step of inserting the positive electrode terminal side covered metal member 66 into the inside of the positive electrode terminal side mounting hole 61 and simultaneously crushing the positive electrode terminal side covered metal member 66 in the inside of the positive electrode terminal side mounting hole 61 so as to join the metal plate 19 and the positive electrode terminal side covered metal member 66 by using the positive electrode terminal side interposing layer 64 as a boundary while expanding the positive electrode terminal side mounting hole 61, and inserting the negative electrode terminal side covered metal member 70 into the inside of the negative electrode terminal side mounting hole 62 and simultaneously crushing the negative electrode terminal side covered metal member 70 in the inside of the negative electrode terminal side mounting hole 62 so as to join the metal plate 19 and the negative electrode terminal side covered metal member 70 by using the negative electrode terminal side interposing layer 68 as a boundary while expanding the negative electrode terminal side mounting hole 62 is particularly carried out to crush the positive electrode terminal side covered metal member 66 in the inside of the positive electrode terminal side mounting hole 61 and simultaneously crush the negative electrode terminal side covered metal member 70 in the inside of the negative electrode terminal side mounting hole 62 by a blanking punch of a press device (refer to FIGS. 6D and 6E).

At this time, the positive electrode terminal side covered metal member 66 is crushed, and is rolled so as to have a diameter larger than the positive electrode terminal side mounting hole 61, in association with this, the positive electrode terminal side mounting hole 61 is expanded. As a result, even if an oxide film is slightly formed in the inner peripheral surface of the positive electrode terminal side mounting hole 61, the oxide film is broken just before the joining, and generation of a newly formed surface is accelerated so that diffusion joining can be carried out between a metal of the metal plate 19 and a metal of the positive electrode terminal side interposing layer 64.

Consequently, the metal of the metal plate 19 and the metal of the positive electrode terminal side interposing layer 64 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the metal plate 19 and the metal of the positive electrode terminal side interposing layer 64, and the metal of the positive electrode terminal side interposing layer 64 and aluminum or the like of the positive electrode terminal side metal rod 63 have the respective ionization tendencies being close together, thus even if these mutually different kinds of metals are joined, in principle, corrosion and increase in resistance by a local battery effect is hard to occur.

Similarly, the negative electrode terminal side covered metal member 70 is crushed, and is rolled so as to have a diameter larger than the inner diameter of the negative electrode terminal side mounting hole 62, in association with this, the negative electrode terminal side mounting hole 62 is expanded. As a result, even if an oxide film is slightly formed in the inner peripheral surface of the negative electrode terminal side mounting hole 62, the oxide film is broken just before the joining, and generation of a newly formed surface is accelerated so that diffusion joining can be carried out between a metal of the metal plate 19 and a metal of the negative electrode terminal side interposing layer 68.

Consequently, the metal of the metal plate 19 and the metal of the negative electrode terminal side interposing layer 68 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the metal plate 19 and the metal of the negative electrode terminal side interposing layer 68, and the metal of the negative electrode terminal side interposing layer 68 and copper or the like of the negative electrode terminal side metal rod 67 have the respective ionization tendencies being close together, thus even if these mutually different kinds of metals are joined, in principle, corrosion and increase in resistance by a local battery effect is hard to occur.

Further, it is preferable that the steps of forming the positive electrode terminal side covered metal member 66 and the negative electrode terminal side covered metal member 70 are preliminarily carried out before the steps of forming the positive electrode terminal side mounting hole 61 and the negative electrode terminal side mounting hole 62. The positive electrode terminal side covered metal member 66 and the negative electrode terminal side covered metal member 70 are prepared first, and then the positive electrode terminal side mounting hole 61 and the negative electrode terminal side mounting hole 62 are formed, thereby a time from the forming of the positive electrode terminal side mounting hole 61 to the joining of the metal plate 19 and the positive electrode terminal side covered metal member 66, and from the forming of the negative electrode terminal side mounting hole 62 to the joining of the metal plate 19 and the negative electrode terminal side covered metal member 70 can be shortened, thus growth of the oxide film can be prevented.

In addition, a press processing has a processing speed higher than the other processing method, thus the above-mentioned steps can be continuously carried out by a press device, thereby the time can be further shortened. Consequently, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by expansion is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the positive electrode terminal side covered metal member 66 and the negative electrode terminal side covered metal member 70 so as to form the positive electrode terminal fixing hole 17 and the negative electrode terminal fixing hole 18, and fabricate the positive electrode terminal connection part 13 and the negative electrode terminal connection part 14 (refer to FIG. 6F).

In the step, a press processing is applied to the center part of the positive electrode terminal side covered metal member 66 to allow the positive electrode terminal side metal rod 63 to remain in the inner peripheral side of the positive electrode terminal side mounting hole 61 so as to form the positive electrode terminal fixing hole 17, and simultaneously a press processing is applied to the center part of the negative electrode terminal side covered metal member 70 to allow the negative electrode terminal side metal rod 67 to remain in the inner peripheral side of the negative electrode terminal side mounting hole 62 so as to form the negative electrode terminal fixing hole 18.

Thereby, when the positive electrode terminal 11 is inserted into the positive electrode terminal fixing hole 17 so as to be fixed by resistance welding or the like, the positive electrode terminal 11 and a part of the positive electrode terminal side metal rod 63 that are mutually formed of the same kind of metal are brought into contact with each other, and when the negative electrode terminal 12 is inserted into the negative electrode terminal fixing hole 18 so as to be fixed by resistance welding or the like, the negative electrode terminal 12 and a part of the negative electrode terminal side metal rod 67 that are mutually formed of the same kind of metal are brought into contact with each other so that the joining of the mutually same kind of metal can be realized.

Further, when the positive electrode terminal fixing hole 17 and the negative electrode terminal fixing hole 18 are formed, in order to prevent the joining of mutually different kinds of metals, it is preferable that the positive electrode terminal side interposing layer 64 and the negative electrode terminal side interposing layer 68 are not exposed in the inner peripheral surfaces of the positive electrode terminal fixing hole 17 that comes into contact with the positive electrode terminal 11 and the negative electrode terminal fixing hole 18 that comes into contact with the negative electrode terminal 12.

In addition, it is preferable that the expansion type manufacturing method for obtaining the second electrode terminal connection body 200 further includes the step of heating under an inert atmosphere after joining the metal plate 19 and the positive electrode terminal side covered metal member 66 and joining the metal plate 19 and the negative electrode terminal side covered metal member 70 (refer to FIG. 6G).

Thereby, diffusion joining between the metal of the metal plate 19 and the metal of the positive electrode terminal side interposing layer 64, and diffusion joining between the metal of the metal plate 19 and metal of the negative electrode terminal side interposing layer 68 are sufficiently progressed so that joining strength can be further heightened.

As the inert atmosphere, a helium gas atmosphere or an argon gas atmosphere can be used. The heating temperature is controlled to a temperature not more than the melting point of the metal plate 19, the positive electrode terminal side metal rod 63, the positive electrode terminal side interposing layer 64, the negative electrode terminal side metal rod 67 and the negative electrode terminal side interposing layer 68 that are base materials.

When the nonaqueous electrolyte secondary batteries 16 are connected in series-parallel via the second electrode terminal connection body 200 obtained by the above-mentioned steps, the positive electrode terminal fixing hole 17 of the second electrode terminal connection body 200 and the positive electrode terminal 11 of the one nonaqueous electrolyte secondary battery 16 are fixed by resistance welding or the like, and the negative electrode terminal fixing hole 18 of the second electrode terminal connection body 200 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the positive electrode terminal side metal rod 63 that is the same kind of metal as a metal of the positive electrode terminal 11, and the negative electrode terminal fixing hole 18 that comes into contact with the negative electrode terminal 12 is formed of the negative electrode terminal side metal rod 67 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Next, the press-fitting type manufacturing method will be explained.

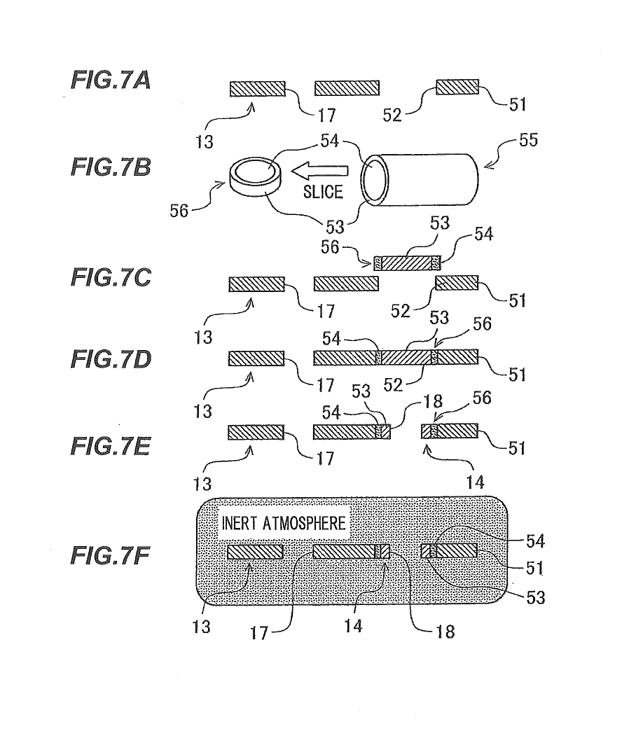

As shown in FIGS. 7A to 7F, the press-fitting type manufacturing method for obtaining the first electrode terminal connection body 100 includes applying a press processing to a plate member 51 formed of the same kind of metal as a metal of the positive electrode terminal 11 so as to form a mounting hole 52, slicing a covered metal rod 55 in the same thickness as the plate member 51 so as to form a covered metal member 56, the covered metal rod 55 being configured to include an interposing layer 54 formed of a metal that has an ionization tendency between the metal of the positive electrode terminal 11 and the metal of the negative electrode terminal 12 in the outer periphery of a metal rod 53 formed of the same kind of metal as a metal of the negative electrode terminal 12 and to have a diameter larger than the mounting hole 52, and press-fitting the covered metal member 56 into the inside of the mounting hole 52 so as to join the plate member 51 and the covered metal member 56 by using the interposing layer 54 as a boundary.

Further, in FIGS. 7A to 7F, for convenience of explanation, a part of lines in the cross-sectional views is omitted.

Hereinafter, the respective steps will be concretely explained.

The step of applying a press processing to the plate member 51 formed of the same kind of metal as a metal of the positive electrode terminal 11 so as to form the mounting hole 52 is particularly carried out to apply a press processing (especially, a punching work) to the plate member 51 formed of aluminum or an aluminum alloy so as to form the mounting hole 52, and further to form the positive electrode terminal fixing hole 17 so as to form the positive electrode terminal connection part 13 (refer to FIG. 7A). Just after this step, an oxidizing film is not formed in the inner peripheral surface of the mounting hole 52.

Thereby, when the positive electrode terminal 11 is inserted into the positive electrode terminal fixing hole 17 so as to be fixed by resistance welding or the like, the positive electrode terminal 11 and the plate member 51 that are mutually formed of the same kind of metal are brought into contact with each other so that the joining of the mutually same kind of metal can be realized.

The step of slicing a covered metal rod 55 more thickly than the plate member 51 so as to form a covered metal member 56, the covered metal rod 55 being configured to include an interposing layer 54 formed of a metal that has an ionization tendency between the metal of the positive electrode terminal 11 and the metal of the negative electrode terminal 12 in the outer periphery of a metal rod 53 formed of the same kind of metal as a metal of the negative electrode terminal 12 and to have a diameter smaller than the mounting hole 52 is particularly carried out to cover the outer periphery of the metal rod 53 formed of copper or a copper alloy with the interposing layer 54 formed of nickel, chromium, zinc or the like that becomes the interposing part 15 by a plating processing, a vapor deposition processing or the like so as to form the covered metal rod 55, and slice the covered metal rod 55 by using a slicer or the like so as to form the covered metal member 56 (refer to FIG. 7B).

At this time, it is necessary that the metal rod 53 is configured to have the outer diameter less than the outer diameter (or inner diameter) of the mounting hole 52. The reason is that if the metal rod 53 is configured to have the outer diameter more than the outer diameter of the mounting hole 52, in a post process, when the covered metal member 56 is press-fitted into the mounting hole 52, there is a risk that the interposing layer 54 is scraped so as to disappear, thus an advantage that the plate member 51 is directly joined to the covered metal member 56 so as to form the interposing layer 54 cannot be obtained.

In addition, a plating processing, a vapor deposition processing or the like is adopted, thereby the interposing layer 54 can be adjusted to have a thickness that is necessary and minimum, thus even if the material constituting the interposing layer 54 is not desired for characteristics of the first electrode terminal connection body 100, an influence due to this can be suppressed to a minimum.

Here, a metal of the interposing layer 54 is selected based on an ionization tendency, but a configuration using a base other than the ionization tendency can be adopted, that a metal having a standard electrode potential located between the metal of the positive electrode terminal 11 and the metal of the negative electrode terminal 12 is selected as the metal of the interposing layer 54. The reason is that an ionization permutation exhibiting the ionization tendency corresponds to electrochemical series exhibiting the standard electrode potential that is represented by using hydrogen as a standard electrode.

The step of press-fitting the covered metal member 56 into the inside of the mounting hole 52 so as to join the plate member 51 and the covered metal member 56 by using the interposing layer 54 as a boundary is particularly carried out to press-fit the covered metal member 56 in the inside of the mounting hole 52 by a blanking punch of a press device (refer to FIGS. 7C and 7D).

At this time, the covered metal member 56 and the mounting hole 52 are brought into contact with each other so that the covered metal member 56 is press-fitted into the inside of the mounting hole 52 while being mutually scraped in their surfaces and performing plastic deformation. As a result, even if an oxide film is slightly formed in the inner peripheral surface of the positive electrode terminal fixing hole 17 positive electrode terminal fixing hole 17 mounting hole 52, the oxide film is broken just before the joining, and generation of a newly formed surface is accelerated so that diffusion joining can be carried out between aluminum or the like of the plate member 51 and nickel or the like of the interposing layer 54.

Consequently, aluminum or the like of the plate member 51 and nickel or the like of the interposing layer 54 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, aluminum or the like of the plate member 51 and nickel or the like of the interposing layer 54, and nickel or the like of the interposing layer 54 and copper or the like of the metal rod 53 have the respective ionization tendencies being close together, thus even if these mutually different kinds of metals are joined, in principle, corrosion and increase in resistance by a local battery effect is hard to occur.

Further, it is preferable that the step of forming the covered metal member 56 is preliminarily carried out before the step of forming the mounting hole 52. The covered metal member 56 is prepared first, and then the mounting hole 52 is formed, thereby a time from the forming of the mounting hole 52 to the joining of the plate member 51 and the covered metal member 56 can be shortened, thus growth of the oxide film can be prevented.

In addition, a press processing has a processing speed higher than the other processing method, thus the above-mentioned steps can be continuously carried out by a press device, thereby the time can be further shortened. Consequently, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by expansion is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the covered metal member 56 joined to the plate member 51 by using the interposing layer 54 as a boundary so as to form the negative electrode terminal fixing hole 18 and fabricate the negative electrode terminal connection part 14 (refer to FIG. 7E).

At this time, a press processing is applied to the center part of the covered metal member 56 to allow the metal rod 53 to remain in the inner peripheral part of the mounting hole 52 so as to form the negative electrode terminal fixing hole 18.

Thereby, when the negative electrode terminal 12 is inserted into the negative electrode terminal fixing hole 18 so as to be fixed by resistance welding or the like, the negative electrode terminal 12 and a part of the metal rod 53 that are mutually formed of the same kind of metal are brought into contact with each other so that the joining of the mutually same kind of metal can be realized.

Further, when the negative electrode terminal fixing hole 18 is formed, in order to prevent the joining of mutually different kinds of metals it is preferable that the interposing layer 54 is not exposed in the inner peripheral surface of the negative electrode terminal fixing hole 18 that comes into contact with the negative electrode terminal 12.

In addition, it is preferable that the press-fitting type manufacturing method for obtaining the first electrode terminal connection body 100 further includes the step of heating under an inert atmosphere after joining the plate member 51 and the covered metal member 56 (refer to FIG. 7F).

Thereby, diffusion joining between aluminum or the like of the plate member 51 and nickel or the like of the interposing layer 54 and diffusion joining between nickel or the like of the interposing layer 54 and copper or the like of the metal rod 53 are sufficiently progressed so that joining strength can be further heightened.

As the inert atmosphere, a helium gas atmosphere or an argon gas atmosphere can be used. The heating temperature is controlled to a temperature not more than the melting point of the plate member 51, the metal rod 53 and the interposing layer 54 that are base materials.

When the nonaqueous electrolyte secondary batteries 16 are connected in series-parallel via the first electrode terminal connection body 100 obtained by the above-mentioned steps, the positive electrode terminal fixing hole 17 of the first electrode terminal connection body 100 and the positive electrode terminal 11 of the one nonaqueous electrolyte secondary battery 16 are fixed by resistance welding or the like, and the negative electrode terminal fixing hole 18 of the first electrode terminal connection body 100 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the plate member 51 that is the same kind of metal as a metal of the positive electrode terminal 11, and the negative electrode terminal fixing hole 18 that comes into contact with the negative electrode terminal 12 is formed of the a part of the metal rod 53 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Further, in the embodiment, the plate member 51 is formed of aluminum or the like that is the same kind of metal as a metal of the positive electrode terminal 11 and the metal rod 53 is formed of copper or the like that is the same kind of metal as a metal of the negative electrode terminal 12, but not limited to this, a configuration that the plate member 51 is formed of copper or the like that is the same kind of metal as a metal of the negative electrode terminal 12 and the metal rod 53 is formed of aluminum or the like that is the same kind of metal as a metal of the positive electrode terminal 11 may be also adopted.

Also in this case, when the mounting hole 52 and the covered metal member 56 are joined, even if an oxide film is slightly formed in the inner peripheral surface of the mounting hole 52, the oxide film is broken just before the joining, and generation of a newly formed surface is accelerated so that sufficient joining strength can be obtained between mutually different kinds of metals.

In addition, in the embodiment, the covered metal rod 55 is formed by covering the outer periphery of the metal rod 53 with the interposing layer 54 by a plating processing, a vapor deposition processing or the like, but limited to this, a configuration that a metal that becomes the metal rod 53 is press-fitted into the inside of a pipe member that becomes the interposing layer 54 and the obtained product is extended so as to form the covered metal rod 55 can be also adopted.

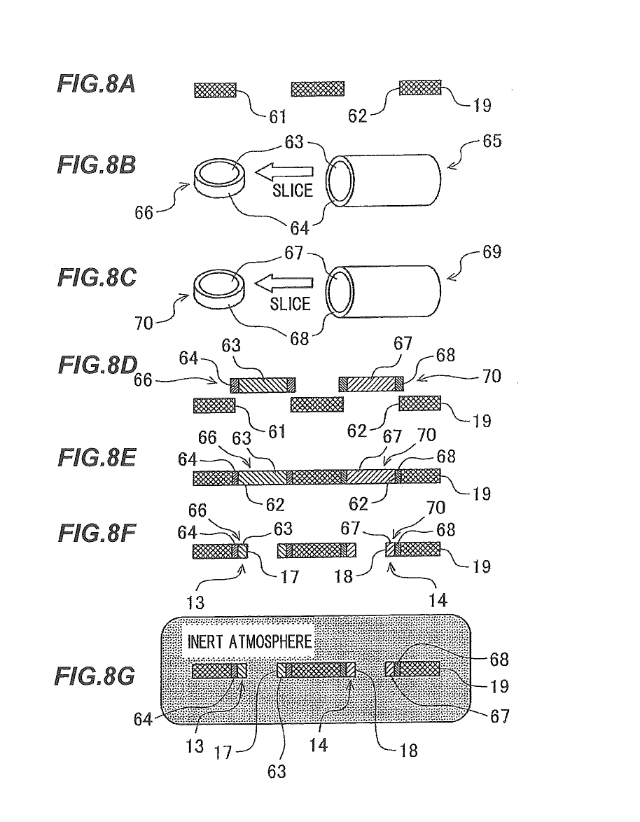

As shown in FIGS. 8A to 8G the press-fitting type manufacturing method for obtaining the second electrode terminal connection body 200 includes applying a press processing to a metal plate 19 so as to form a positive electrode terminal side mounting hole positive electrode terminal side mounting hole 61 and a negative electrode terminal side mounting hole 62, slicing a positive electrode terminal side covered metal rod 65 in the same thickness as the metal plate 19 so as to form a positive electrode terminal side covered metal member 66, the positive electrode terminal side covered metal rod 65 being configured to include a positive electrode terminal side interposing layer 64 formed of a metal that has an ionization tendency between the metal of the positive electrode terminal 11 and the metal of the metal plate 19 in the outer periphery of a positive electrode terminal side metal rod 63 formed of the same kind of metal as a metal of the positive electrode terminal 11 and to have a diameter larger than the positive electrode terminal side mounting hole 61, slicing a negative electrode terminal side covered metal rod 69 in the same thickness as the metal plate 19 so as to form a negative electrode terminal side covered metal member 70, the negative electrode terminal side covered metal rod 69 being configured to include a negative electrode terminal side interposing layer 68 formed of a metal that has an ionization tendency between the metal of the negative electrode terminal 12 and the metal of the metal plate 19 in the outer periphery of a negative electrode terminal side metal rod 67 formed of the same kind of metal as a metal of the negative electrode terminal 12 and to have a diameter larger than the negative electrode terminal side mounting hole 62 and press-fitting the positive electrode terminal side covered metal member 66 into the inside of the positive electrode terminal side mounting hole 61 so as to join the plate member 19 and the positive electrode terminal side covered metal member 66 by using the positive electrode terminal side interposing layer 64 as a boundary and press-fitting the negative electrode terminal side covered metal member 70 into the inside of the negative electrode terminal side mounting hole 62 so as to join the plate member 19 and the negative electrode terminal side covered metal member 70 by using the negative electrode terminal side interposing layer 68 as a boundary.

Further, in FIGS. 8A to 8Q for convenience of explanation, a part of lines in the cross-sectional views is omitted.

Hereinafter, the respective steps will be concretely explained.

The step of applying a press processing to the metal plate 19 so as to form the positive electrode terminal side mounting hole 61 and the negative electrode terminal side mounting hole 62 is particularly carried out to apply a press processing (especially, a punching work) to the metal plate 19 formed of various materials in accordance with purposes such as an aluminum based material or a copper based material so as to form the positive electrode terminal side mounting hole 61 and the negative electrode terminal side mounting hole 62 (refer to FIG. 8A). Just after this step, an oxidizing film is not formed in the inner peripheral surfaces of the positive electrode terminal side mounting hole 61 and the negative electrode terminal side mounting hole 62.

The step of slicing the positive electrode terminal side covered metal rod 65 in the same thickness as the metal plate 19 so as to form the positive electrode terminal side covered metal member 66, the positive electrode terminal side covered metal rod 65 being configured to include a positive electrode terminal side interposing layer 64 formed of a metal that has an ionization tendency between the metal of the positive electrode terminal 11 and the metal of the metal plate 19 in the outer periphery of the positive electrode terminal side metal rod 63 formed of the same kind of metal as a metal of the positive electrode terminal 11 and to have a diameter larger than the positive electrode terminal side mounting hole 61 is particularly carried out to cover the outer periphery of the positive electrode terminal side metal rod 63 formed of aluminum or an aluminum alloy with the positive electrode terminal side interposing layer 64 that becomes the positive electrode terminal side interposing part 20 by a plating processing, a vapor deposition processing or the like so as to form the positive electrode terminal side covered metal rod 65, and slice the positive electrode terminal side covered metal rod 65 by using a slicer or the like so as to form the positive electrode terminal side covered metal member 66 (refer to FIG. 8B).

The step of slicing the negative electrode terminal side covered metal rod 69 in the same thickness as the metal plate 19 so as to form a negative electrode terminal side covered metal member 70, the negative electrode terminal side covered metal rod 69 being configured to include a negative electrode terminal side interposing layer 68 formed of a metal that has an ionization tendency between the metal of the negative electrode terminal 12 and the metal of the metal plate 19 in the outer periphery of a negative electrode terminal side metal rod 67 formed of the same kind of metal as a metal of the negative electrode terminal 12 and to have a diameter larger than the negative electrode terminal side mounting hole 62 is particularly carried out to cover the outer periphery of the negative electrode terminal side metal rod 67 formed of copper or a copper alloy with the negative electrode terminal side interposing layer 68 that becomes the negative electrode terminal side interposing part 21 by a plating processing, a vapor deposition processing or the like so as to form the negative electrode terminal side covered metal rod 69, and slice the negative electrode terminal side covered metal rod 69 by using a slicer or the like so as to form the negative electrode terminal side covered metal member 70 (refer to FIG. 8C).

At this time, it is necessary that the positive electrode terminal side metal rod 63 is configured to have the outer diameter less than the outer diameter of the positive electrode terminal side mounting hole 61, and the negative electrode terminal side metal rod 67 is configured to have the outer diameter less than the outer diameter of the negative electrode terminal side mounting hole 62. The reason is that if the positive electrode terminal side metal rod 63 is configured to have the outer diameter more than the outer diameter of the positive electrode terminal side mounting hole 61, or the negative electrode terminal side metal rod 67 is configured to have the outer diameter more than the outer diameter of the negative electrode terminal side mounting hole 62, in a post process, when the positive electrode terminal side covered metal member 66 and the negative electrode terminal side covered metal member 70 are press-fitted into the positive electrode terminal side mounting hole 61 or the negative electrode terminal side mounting hole 62, there is a risk that the positive electrode terminal side interposing layer 64 and the negative electrode terminal side interposing layer 68 are scraped so as to disappear, thus an advantage that the metal plate 19 is directly joined to the positive electrode terminal side covered metal member 66 and the negative electrode terminal side covered metal member 70 so as to form the positive electrode terminal side interposing layer 64 and the negative electrode terminal side interposing layer 68 cannot be obtained.

A plating processing, a vapor deposition processing or the like is adopted, thereby the positive electrode terminal side interposing layer 64 and the negative electrode terminal side interposing layer 68 can be adjusted to have a thickness that is necessary and minimum, thus even if the materials constituting the positive electrode terminal side interposing layer 64 and the negative electrode terminal side interposing layer 68 are not desired for characteristics of the second electrode terminal connection body 200, an influence due to this can be suppressed to a minimum.

Here, metals of the positive electrode terminal side interposing layer 64 and the negative electrode terminal side interposing layer 68 are selected based on an ionization tendency, but a configuration using a base other than the ionization tendency can be adopted, that a metal having a standard electrode potential located between the metal of the positive electrode terminal 11 and the metal of the metal plate 19 is selected as the metal of the positive electrode terminal side interposing layer 64, and a metal having a standard electrode potential located between the metal of the negative electrode terminal 12 and the metal of the metal plate 19 is selected as the metal of the negative electrode terminal side interposing layer 68. The reason is that an ionization permutation exhibiting the ionization tendency corresponds to electrochemical series exhibiting the standard electrode potential that is represented by using hydrogen as a standard electrode.

The step of press-fitting the positive electrode terminal side covered metal member 66 into the inside of the positive electrode terminal side mounting hole 61 so as to join the plate member 19 and the positive electrode terminal side covered metal member 66 by using the positive electrode terminal side interposing layer 64 as a boundary and press-fitting the negative electrode terminal side covered metal member 70 into the inside of the negative electrode terminal side mounting hole 62 so as to join the plate member 19 and the negative electrode terminal side covered metal member 70 by using the negative electrode terminal side interposing layer 68 as a boundary is particularly carried out to press-fit the positive electrode terminal side covered metal member 66 in the inside of the positive electrode terminal side mounting hole 61 and simultaneously press-fit the negative electrode terminal side covered metal member 70 in the inside of the negative electrode terminal side mounting hole 62 by a blanking punch of a press device (refer to FIGS. 8D and 8E).

At this time, the positive electrode terminal side covered metal member 66 and the positive electrode terminal side mounting hole 61 are brought into contact with each other so that the positive electrode terminal side covered metal member 66 is press-fitted into the inside of the positive electrode terminal side mounting hole 61 while being mutually scraped in their surfaces and performing plastic deformation. As a result, even if an oxide film is slightly formed in the inner peripheral surface of the positive electrode terminal side mounting hole 61, the oxide film is broken just before the joining, and generation of a newly formed surface is accelerated so that diffusion joining can be carried out between the metal of the metal plate 19 and the metal of the positive electrode terminal side interposing layer 64.

Consequently, the metal of the metal plate 19 and the metal of the positive electrode terminal side interposing layer 64 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the metal plate 19 and the metal of the positive electrode terminal side interposing layer 64, the metal of the positive electrode terminal side interposing layer 64 and aluminum or the like of the positive electrode terminal side metal rod 63 have the respective ionization tendencies being close together, thus even if these mutually different kinds of metals are joined, in principle, corrosion and increase in resistance by a local battery effect is hard to occur.

Similarly, the negative electrode terminal side covered metal member 70 and the negative electrode terminal side mounting hole 62 are brought into contact with each other so that the negative electrode terminal side covered metal member 70 is press-fitted into the inside of the negative electrode terminal side mounting hole 62 while being mutually scraped in their surfaces and performing plastic deformation. As a result, even if an oxide film is slightly formed in the inner peripheral surface of the negative electrode terminal side mounting hole 62, the oxide film is broken just before the joining, and generation of a newly formed surface is accelerated so that diffusion joining can be carried out between the metal of the metal plate 19 and the metal of the negative electrode terminal side interposing layer 68.

Consequently, the metal of the metal plate 19 and the metal of the negative electrode terminal side interposing layer 68 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the metal plate 19 and the metal of the negative electrode terminal side interposing layer 68, the metal of the negative electrode terminal side interposing layer 68 and copper or the like of the negative electrode terminal side metal rod 67 have the respective ionization tendencies being close together, thus even if these mutually different kinds of metals are joined, in principle, corrosion and increase in resistance by a local battery effect is hard to occur.

Further, it is preferable that the steps of forming the positive electrode terminal side covered metal member 66 and the negative electrode terminal side covered metal member 70 are preliminarily carried out before the steps of forming the positive electrode terminal side mounting hole 61 and the negative electrode terminal side mounting hole 62. The positive electrode terminal side covered metal member 66 and the negative electrode terminal side covered metal member 70 are prepared first, and then the positive electrode terminal side mounting hole 61 and the negative electrode terminal side mounting hole 62 are formed, thereby a time from the forming of the positive electrode terminal side mounting hole 61 to the joining of the metal plate 19 and the positive electrode terminal side covered metal member 66, and from the forming of the negative electrode terminal side mounting hole 62 to the joining of the metal plate 19 and the negative electrode terminal side covered metal member 70 can be shortened, thus growth of the oxide film can be prevented.

In addition, a press processing has a processing speed higher than the other processing method, thus the above-mentioned steps can be continuously carried out by a press device, thereby the time can be further shortened. Consequently, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by expansion is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the positive electrode terminal side covered metal member 66 and the negative electrode terminal side covered metal member 70 so as to form the positive electrode terminal fixing hole 17 and the negative electrode terminal fixing hole 18, and fabricate the positive electrode terminal connection part 13 and the negative electrode terminal connection part 14 (refer to FIG. 8F).

In the step, a press processing is applied to the center part of the positive electrode terminal side covered metal member 66 to allow the positive electrode terminal side metal rod 63 to remain in the inner peripheral side of the positive electrode terminal side mounting hole 61 so as to form the positive electrode terminal fixing hole 17, and simultaneously a press processing is applied to the center part of the negative electrode terminal side covered metal member 70 to allow the negative electrode terminal side metal rod 67 to remain in the inner peripheral side of the negative electrode terminal side mounting hole 62 so as to form the negative electrode terminal fixing hole 18.

Thereby, when the positive electrode terminal 11 is inserted into the positive electrode terminal fixing hole 17 so as to be fixed by resistance welding or the like, the positive electrode terminal 11 and a part of the positive electrode terminal side metal rod 63 that are mutually formed of the same kind of metal are brought into contact with each other, and when the negative electrode terminal 12 is inserted into the negative electrode terminal fixing hole 18 so as to be fixed by resistance welding or the like, the negative electrode terminal 12 and a part of the negative electrode terminal side metal rod 67 that are mutually formed of the same kind of metal are brought into contact with each other so that the joining of the mutually same kind of metal can be realized.

Further, when the positive electrode terminal fixing hole 17 and the negative electrode terminal fixing hole 18 are formed, in order to prevent the joining of mutually different kinds of metals, it is preferable that the positive electrode terminal side interposing layer 64 and the negative electrode terminal side interposing layer 68 are not exposed in the inner peripheral surfaces of the positive electrode terminal fixing hole 17 that comes into contact with the positive electrode terminal 11 and the negative electrode terminal fixing hole 18 that comes into contact with the negative electrode terminal 12.

In addition, it is preferable that the press-fitting type manufacturing method for obtaining the second electrode terminal connection body 200 further includes the step of heating under an inert atmosphere after joining the metal plate 19 and the positive electrode terminal side covered metal member 66 and joining the metal plate 19 and the negative electrode terminal side covered metal member 70 (refer to FIG. 8G).

Thereby, diffusion joining between the metal of the metal plate 19 and the metal of the positive electrode terminal side interposing layer 64, and diffusion joining between the metal of the metal plate 19 and metal of the negative electrode terminal side interposing layer 68 are sufficiently progressed so that joining strength can be further heightened.

As the inert atmosphere, a helium gas atmosphere or an argon gas atmosphere can be used. The heating temperature is controlled to a temperature not more than the melting point of the metal plate 19, the positive electrode terminal side metal rod 63, the positive electrode terminal side interposing layer 64, the negative electrode terminal side metal rod 67 and the negative electrode terminal side interposing layer 68 that are base materials.

When the nonaqueous electrolyte secondary batteries 16 are connected in series-parallel via the second electrode terminal connection body 200 obtained by the above-mentioned steps, the positive electrode terminal fixing hole 17 of the second electrode terminal connection body 200 and the positive electrode terminal 11 of the one nonaqueous electrolyte secondary battery 16 are fixed by resistance welding or the like, and the negative electrode terminal fixing hole 18 of the second electrode terminal connection body 200 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the positive electrode terminal side metal rod 63 that is the same kind of metal as a metal of the positive electrode terminal 11, and the negative electrode terminal fixing hole 18 that comes into contact with the negative electrode terminal 12 is formed of the negative electrode terminal side metal rod 67 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Next, an operation and effect of the manufacturing method of the electrode terminal connection body of the third embodiment of the invention will be explained.

The electrode terminal connection bodies described in JP-A-2011-210482 and JP-A-2012-89254 are manufactured by forming an intermediate product in which mutually different kinds of metals are joined, by a hydrostatic extrusion processing, and applying to the intermediate product so as to obtain an electrode terminal connection body having a plate-like shape.

In order to carry out a hydrostatic extrusion processing, a large-scaled facility is needed, and in order to apply a cutting processing to the intermediate product so as to obtain an electrode terminal connection body having a plate-like shape, a long time is needed and simultaneously waste of chip is increased, thus it is estimated that production cost is extremely increased.

In addition, JP-A-2011-210482 discloses that an electrode terminal connection body is manufactured by forming a mounting hole in a plate material and press-fitting a metal member formed of a different kind of metal into the mounting hole, but there is a risk that before the metal member is press-fitted into the mounting hole, an oxide film is grown on the surface of aluminum or an aluminum alloy so that sufficient joining strength cannot be obtained between mutually different kinds of metals.

On the other hand, in accordance with the manufacturing method of the electrode terminal connection body according to the embodiment, the steps from the forming of the mounting hole 52, and the positive electrode terminal side mounting hole 61 and the negative electrode terminal side mounting hole 62 to the joining of the covered metal member 56, and the positive electrode terminal side covered metal member 66 and the negative electrode terminal side covered metal member 70 are carried out by a press processing that is excellent in a processing speed and can be operated by a small-scaled facility in comparison with a hydrostatic extrusion processing, so that a large-scaled facility is not needed and the steps from the forming of the mounting hole 52, and the positive electrode terminal side mounting hole 61 and the negative electrode terminal side mounting hole 62 to the joining of the covered metal member 56, and the positive electrode terminal side covered metal member 66 and the negative electrode terminal side covered metal member 70 can be carried out in a short time.

In addition, in the manufacturing method of the electrode terminal connection body, the processing speed of the steps from the forming of the mounting hole 52, and the positive electrode terminal side mounting hole 61 and the negative electrode terminal side mounting hole 62 to the joining of the covered metal member 56, and the positive electrode terminal side covered metal member 66 and the negative electrode terminal side covered metal member 70 is higher than that of a case of using a hydrostatic extrusion processing and/or a cutting processing together so that the growth of oxide film can be prevented during the processing.

Furthermore, in the manufacturing method of the electrode terminal connection body, when the mounting hole 52 and the covered metal member 56 are joined, when the positive electrode terminal side mounting hole 61 and the positive electrode terminal side covered metal member 66 are joined, and when the negative electrode terminal side mounting hole 62 and the negative electrode terminal side covered metal member 70, even if an oxide film is slightly formed in the inner peripheral surfaces of the mounting hole 52, the positive electrode terminal side mounting hole 61, or the negative electrode terminal side mounting hole 62, just before the joining, the oxide film can be broken and diffusion joining can be applied to mutually different kinds of metals so that sufficient joining strength can be obtained between mutually different kinds of metals.

Namely, in accordance with the manufacturing method of the electrode terminal connection body according to the embodiment, a large-scaled facility is not needed and the steps from the forming of the mounting hole to the joining of the metal member can be carried out in a short time, so that the first electrode terminal connection body 100 can be obtained, the first electrode terminal connection body 100 being capable of preventing the growth of oxide film to a minimum so as to be joined and realizing a sufficient joining strength between mutually different kinds of metals.

In addition, the electrode terminal connection bodies described in JP-A-2011-210482 and JP-A-2012-89254 are configured such that the main base material occupying most of the whole volume is formed of the same kind of metal as a metal of the electrode terminal, thus there is hardly any room to select a material of the main base material in relation with the metal of which the electrode terminal is formed.

The main base material formed of the same kind of metal as a metal of the electrode terminal does not always have sufficient strength as an electrode terminal connection body, and does not always have low resistance, thus it is desired to provide an electrode terminal connection body configured such that a main base material can be freely selected.

On the other hand, in accordance with the manufacturing method of the electrode terminal connection body according to the embodiment, the main base material that occupies most of the whole volume is formed of the metal plate 19, thus a material of the metal plate 19 is changed in accordance with purposes, thereby materials having various characteristics can be freely used as the main base material.

Namely, in accordance with the manufacturing method of the electrode terminal connection body according to the embodiment, the second electrode terminal connection body 200 can be obtained, the second electrode terminal connection body 200 being configured such that a main base material occupying most of the whole volume is not limited due to the metal of which the electrode terminal is formed, and materials having various characteristics can be freely used, and being capable of preventing an occurrence of corrosion and increase in resistance in the joining part thereof.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

The embodiment is configured such that in the expansion type manufacturing method, all of the joinings are carried out by the expansion, and in the press-fitting type manufacturing method, all of the joinings are carried out by the press-fitting, but not limited to this, a combination of the joining by the expansion and the joining by the press-fitting may be also adopted.

As mentioned above, according to the invention, a manufacturing method of an electrode terminal connection body can be provided, the manufacturing method of an electrode terminal connection body being capable of preventing an occurrence of corrosion and increase in resistance in the joining part thereof.

What is claimed is:

1. A manufacturing method for an electrode terminal connection body configured to electrically connect a positive electrode terminal and a negative electrode terminal that are formed of mutually different kinds of metals, comprising:
applying a press processing to a plate member formed of the same kind of metal as a metal of the positive electrode terminal so as to form a mounting hole;
slicing a covered metal rod more thickly than the plate member so as to form a covered metal member, the covered metal rod being configured to include an interposing layer formed of a metal that has an ionization tendency between the metal of the positive electrode terminal and the metal of the negative electrode terminal in the outer periphery of a metal rod formed of the same kind of metal as a metal of the negative electrode terminal and to have a diameter smaller than the mounting hole; and
inserting the covered metal member into the inside of the mounting hole and simultaneously crushing the covered metal member in the inside of the mounting hole so as to join the plate member and the covered metal member by using the interposing layer as a boundary while expanding the mounting hole.

2. The manufacturing method for an electrode terminal connection body according to claim 1, further comprising:
applying a press processing to the plate member so as to form a positive electrode terminal fixing hole; and
applying a press processing to the center part of the covered metal member to allow the covered metal member to remain in the inner peripheral part of the mounting hole so as to form a negative electrode terminal fixing hole.

3. A manufacturing method for an electrode terminal connection body configured to electrically connect a positive electrode terminal and a negative electrode terminal that are formed of mutually different kinds of metals, comprising:
applying a press processing to a plate member formed of the same kind of metal as a metal of the negative electrode terminal so as to form a mounting hole;
slicing a covered metal rod more thickly than the plate member so as to form a covered metal member, the covered metal rod being configured to include an interposing layer formed of a metal that has an ionization tendency between the metal of the positive electrode terminal and the metal of the negative electrode terminal in the outer periphery of a metal rod formed of the same kind of metal as a metal of the positive electrode terminal and to have a diameter smaller than the mounting hole; and
inserting the covered metal member into the inside of the mounting hole and simultaneously crushing the covered metal member in the inside of the mounting hole so as to join the plate member and the covered metal member by using the interposing layer as a boundary while expanding the mounting hole.

4. The manufacturing method for an electrode terminal connection body according to claim 3, further comprising:
applying a press processing to the plate member so as to form a negative electrode terminal fixing hole; and
applying a press processing to the center part of the covered metal member to allow the covered metal member to remain in the inner peripheral part of the mounting hole so as to form a positive electrode terminal fixing hole.

5. The manufacturing method for an electrode terminal connection body according to claim 1, further comprising:
heating under an inert atmosphere after joining the plate member and the covered metal member.

6. A manufacturing method for an electrode terminal connection body configured to electrically connect a positive electrode terminal and a negative electrode terminal that are formed of mutually different kinds of metals, comprising:
applying a press processing to a metal plate so as to form a positive electrode terminal side mounting hole and a negative electrode terminal side mounting hole;
slicing a positive electrode terminal side covered metal rod more thickly than the metal plate so as to form a positive electrode terminal side covered metal member, the positive electrode terminal side covered metal rod being configured to include a positive electrode terminal side interposing layer formed of a metal that has an ionization tendency between the metal of the positive electrode terminal and the metal of the metal plate in the outer periphery of a positive electrode terminal side metal rod formed of the same kind of metal as a metal of the positive electrode terminal and to have a diameter smaller than the positive electrode terminal side mounting hole;
slicing a negative electrode terminal side covered metal rod more thickly than the metal plate so as to form a negative electrode terminal side covered metal member, the negative electrode terminal side covered metal rod being configured to include a negative electrode terminal side interposing layer formed of a metal that has an ionization tendency between the metal of the negative electrode terminal and the metal of the metal plate in the outer periphery of a negative electrode terminal side metal rod formed of the same kind of metal as a metal of the negative electrode terminal and to have a diameter smaller than the negative electrode terminal side mounting hole; and
inserting the positive electrode terminal side covered metal member into the inside of the positive electrode terminal side mounting hole and simultaneously crushing the positive electrode terminal side covered metal member in the inside of the positive electrode terminal side mounting hole so as to join the metal plate and the positive electrode terminal side covered metal member by using the positive electrode terminal side interposing layer as a boundary while expanding the positive electrode terminal side mounting hole, and inserting the negative electrode terminal side covered metal member into the inside of the negative electrode terminal side mounting hole and simultaneously crushing the negative electrode terminal side covered metal member in the inside of the negative electrode terminal side mounting hole so as to join the metal plate and the negative electrode terminal side covered metal member by using the negative electrode terminal side interposing layer as a boundary while expanding the negative electrode terminal side mounting hole.

7. The manufacturing method for an electrode terminal connection body according to claim 6, wherein the metal plate comprises an aluminum based material or a copper based material.

8. The manufacturing method for an electrode terminal connection body according to claim 6, further comprising:
applying a press processing to the center part of the positive electrode terminal side covered metal member to allow the positive electrode terminal side covered metal member to remain in the inner peripheral part of the positive electrode terminal side mounting hole so as to form a positive electrode terminal fixing hole; and
applying a press processing to the center part of the negative electrode terminal side covered metal member to allow the negative electrode terminal side covered metal member to remain in the inner peripheral part of the negative electrode terminal side mounting hole so as to form a negative electrode terminal fixing hole.

9. The manufacturing method for an electrode terminal connection body according to claim 6, further comprising:
heating under an inert atmosphere after joining the metal plate and the positive electrode terminal side covered metal member and joining the metal plate and the negative electrode terminal side covered metal member.

10. A manufacturing method for an electrode terminal connection body configured to electrically connect a positive electrode terminal and a negative electrode terminal that are formed of mutually different kinds of metals, comprising:
applying a press processing to a plate member formed of the same kind of metal as a metal of the positive electrode terminal so as to form a mounting hole;
slicing a covered metal rod in the same thickness as the plate member so as to form a covered metal member, the covered metal rod being configured to include an interposing layer formed of a metal that has an ionization tendency between the metal of the positive electrode terminal and the metal of the negative electrode terminal in the outer periphery of a metal rod formed of the same kind of metal as a metal of the negative electrode terminal and to have a diameter larger than the mounting hole; and
press-fitting the covered metal member into the inside of the mounting hole so as to join the plate member and the covered metal member by using the interposing layer as a boundary.

11. The manufacturing method for an electrode terminal connection body according to claim 10, further comprising:
applying a press processing to the plate member so as to form a positive electrode terminal fixing hole; and
applying a press processing to the center part of the covered metal member to allow the covered metal member to remain in the inner peripheral part of the mounting hole so as to form a negative electrode terminal fixing hole.

12. A manufacturing method for an electrode terminal connection body configured to electrically connect a positive electrode terminal and a negative electrode terminal that are formed of mutually different kinds of metals, comprising:
applying a press processing to a plate member formed of the same kind of metal as a metal of the negative electrode terminal so as to form a mounting hole;
slicing a covered metal rod in the same thickness as the plate member so as to form a covered metal member, the covered metal rod being configured to include an interposing layer formed of a metal that has an ionization tendency between the metal of the positive electrode terminal and the metal of the negative electrode terminal in the outer periphery of a metal rod formed of the same kind of metal as a metal of the positive electrode terminal and to have a diameter larger than the mounting hole; and
press-fitting the covered metal member into the inside of the mounting hole so as to join the plate member and the covered metal member by using the interposing layer as a boundary.

13. The manufacturing method for an electrode terminal connection body according to claim 12, further comprising:
applying a press processing to the plate member so as to form a negative electrode terminal fixing hole; and
applying a press processing to the center part of the covered metal member to allow the covered metal member to remain in the inner peripheral part of the mounting hole so as to form a positive electrode terminal fixing hole.

14. The manufacturing method for an electrode terminal connection body according to claim 10, further comprising:
heating under an inert atmosphere after joining the plate member and the covered metal member.

15. The manufacturing method for an electrode terminal connection body according to claim 10, wherein the outer diameter of the metal rod is smaller than the mounting hole.

16. A manufacturing method for an electrode terminal connection body configured to electrically connect a positive electrode terminal and a negative electrode terminal that are formed of mutually different kinds of metals, comprising:
applying a press processing to a metal plate so as to form a positive electrode terminal side mounting hole and a negative electrode terminal side mounting hole;
slicing a positive electrode terminal side covered metal rod in the same thickness as the metal plate so as to form a positive electrode terminal side covered metal member, the positive electrode terminal side covered metal rod being configured to include a positive electrode terminal side interposing layer formed of a metal that has an ionization tendency between the metal of the positive electrode terminal and the metal of the metal plate in the outer periphery of a positive electrode terminal side metal rod formed of the same kind of metal as a metal of the positive electrode terminal and to have a diameter larger than the positive electrode terminal side mounting hole;
slicing a negative electrode terminal side covered metal rod in the same thickness as the metal plate so as to form a negative electrode terminal side covered metal member, the negative electrode terminal side covered metal rod being configured to include a negative electrode terminal side interposing layer formed of a metal that has an ionization tendency between the metal of the negative electrode terminal and the metal of the metal plate in the outer periphery of a negative electrode terminal side metal rod formed of the same kind of metal as a metal of the negative electrode terminal and to have a diameter larger than the negative electrode terminal side mounting hole; and
press-fitting the positive electrode terminal side covered metal member into the inside of the positive electrode terminal side mounting hole so as to join the plate member and the positive electrode terminal side covered metal member by using the positive electrode terminal side interposing layer as a boundary and press-fitting the negative electrode terminal side covered metal member into the inside of the negative electrode terminal side mounting hole so as to join the plate member and the negative electrode terminal side covered metal member by using the negative electrode terminal side interposing layer as a boundary.

17. The manufacturing method for an electrode terminal connection body according to claim 16, wherein the metal plate comprises an aluminum based material or a copper based material.

18. The manufacturing method for an electrode terminal connection body according to claim 16, further comprising:
applying a press processing to the center part of the positive electrode terminal side covered metal member to allow the positive electrode terminal side covered metal member to remain in the inner peripheral part of the positive electrode terminal side mounting hole so as to form a positive electrode terminal fixing hole; and
applying a press processing to the center part of the negative electrode terminal side covered metal member to allow the negative electrode terminal side covered metal member to remain in the inner peripheral part of the negative electrode terminal side mounting hole so as to form a negative electrode terminal fixing hole.

19. The manufacturing method for an electrode terminal connection body according to claim 16, further comprising:
heating under an inert atmosphere after joining the metal plate and the positive electrode terminal side covered metal member and joining the metal plate and the negative electrode terminal side covered metal member.

20. The manufacturing method for an electrode terminal connection body according to claim 16, wherein the outer diameter of the positive electrode terminal side metal rod is smaller than the positive electrode terminal side mounting hole, and
wherein the outer diameter of the negative electrode terminal side metal rod is smaller than the negative electrode terminal side mounting hole.

21. An electrode terminal connection body configured to electrically connect a positive electrode terminal and a negative electrode terminal that are formed of mutually different kinds of metals, comprising:
a positive electrode terminal connection part formed of the same kind of metal as a metal of the positive electrode terminal; and
a negative electrode terminal connection part formed of the same kind of metal as a metal of the negative electrode terminal,
wherein the positive electrode terminal connection part and the negative electrode terminal connection part are connected via an interposing part formed of a metal that has an ionization tendency between the metal of the positive electrode terminal and the metal of the negative electrode terminal.

22. An electrode terminal connection body configured to electrically connect a positive electrode terminal and a negative electrode terminal that are formed of mutually different kinds of metals, comprising:
a metal plate;
a positive electrode terminal connection part disposed in a part of the metal plate and formed of the same kind of metal as a metal of the positive electrode terminal; and
a negative electrode terminal connection part disposed in a part of the metal plate and formed of the same kind of metal as a metal of the negative electrode terminal,
wherein the positive electrode terminal connection part and the metal plate are connected via a positive electrode terminal side interposing part formed of a metal that has an ionization tendency between the metal of the positive electrode terminal and the metal of the metal plate, and the negative electrode terminal connection part and the metal plate are connected via a negative electrode terminal side interposing part formed of a metal that has an ionization tendency between the metal of the negative electrode terminal and the metal of the metal plate.

23. An electric storage system, comprising:
a plurality of the nonaqueous electrolyte secondary batteries comprising a positive electrode terminal and a negative electrode terminal; and
an electrode terminal connection body configured to electrically connect the positive electrode terminal and the negative electrode terminal that are formed of mutually different kinds of metals, comprising a positive electrode terminal connection part formed of the same kind of metal as a metal of the positive electrode terminal; and a negative electrode terminal connection part formed of the same kind of metal as a metal of the negative electrode terminal, wherein the positive electrode terminal connection part and the negative electrode terminal connection part are connected via an interposing part formed of a metal that has an ionization tendency between the metal of the positive electrode terminal and the metal of the negative electrode terminal,
wherein the positive electrode terminal connection part of the electrode terminal connection body is connected to the positive electrode terminal of one nonaqueous electrolyte secondary battery and the negative electrode terminal connection part of the electrode terminal connection body is connected to the negative electrode terminal of the other nonaqueous electrolyte secondary battery so that the positive electrode terminal and the negative electrode terminal of the nonaqueous electrolyte secondary batteries are electrically connected in series-parallel via the electrode terminal connection body.

24. An electric storage system, comprising:
a plurality of the nonaqueous electrolyte secondary batteries comprising a positive electrode terminal and a negative electrode terminal; and
an electrode terminal connection body configured to electrically connect the positive electrode terminal and the negative electrode terminal that are formed of mutually different kinds of metals, comprising a metal plate a positive electrode terminal connection part disposed in a part of the metal plate and formed of the same kind of metal as a metal of the positive electrode terminal and a negative electrode terminal connection part disposed in a part of the metal plate and formed of the same kind of metal as a metal of the negative electrode terminal, wherein the positive electrode terminal connection part and the metal plate are connected via a positive electrode terminal side interposing part formed of a metal that has an ionization tendency between the metal of the positive electrode terminal and the metal of the metal plate, and the negative electrode terminal connection part and the metal plate are connected via a negative electrode terminal side interposing part formed of a metal that has an ionization tendency between the metal of the negative electrode terminal and the metal of the metal plate,
wherein the positive electrode terminal connection part of the electrode terminal connection body is connected to the positive electrode terminal of one nonaqueous electrolyte secondary battery and the negative electrode terminal connection part of the electrode terminal connection body is connected to the negative electrode terminal of the other nonaqueous electrolyte secondary battery so that the positive electrode terminal and the negative electrode terminal of the nonaqueous electrolyte secondary batteries are electrically connected in series-parallel via the electrode terminal connection body.
